(19) United States
(12) Patent Application Publication
(10) Pub. No.: US 2002/0147245 A1
(43) Pub. Date: Oct. 10, 2002

(54) Method and apparatus for controlling foam processing

(76) Inventors: Roland Y. Kim, Somerville, MA (US); Jeffrey L. Ng, Framingham, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/826,603

(22) Filed: Apr. 5, 2001

(51) Int. Cl. C08J 9/00

(52) U.S. Cl. 521/50

(57) ABSTRACT

A method and apparatus for controlling foam processing. The method includes acts of receiving a first input indicative of an amount of a polymeric material to be provided to a polymer processing space of a polymer processing apparatus, and automatically determining an amount of a blowing agent to be provided to the polymer processing space to form a foamed product based upon the amount of polymeric material. Additional acts may include automatically configuring a blowing agent delivery system to provide the determined amount of the blowing agent to the polymer processing space to form the foamed product. The method and apparatus may be used to produce microcellular foamed products as well as non-microcellular foamed products, and can be used with a variety of foam processing equipment, such as injection molders, blow molders, and extruders.

### FIELD OF THE INVENTION

The present invention relates generally to polymeric foam processing, and more particularly to microcellular foams and systems and methods of manufacture, and controllers to interface blowing agent pumping and/or metering systems with foam processing equipment, such as injection molders, blow molders, and extruders.

### BACKGROUND OF THE INVENTION

Foamed materials are known, and can be produced by injecting a physical blowing agent into a molten polymeric stream, dispersing the blowing agent in the polymer to form a two-phase mixture of blowing agent cells in polymer, injecting the mixture into a mold having a desired shape, and allowing the mixture to solidify therein. A pressure drop in the mixture can cause the cells in the polymer to grow.

Microcellular material typically is defined by polymeric foam of very small cell size and various microcellular material is described in U.S. Pat. Nos. 4,473,665 and 5,158,986. These patents describe subjecting a single-phase solution of polymeric material and physical blowing agent to thermodynamic instability required to create sites of nucleation of very high density, followed by controlled cell growth to produce microcellular material.

U.S. Pat. No. 4,473,665 (Martini-Vvedensky) describes a molding system and method for producing microcellular parts. Polymeric pellets are pre-pressurized with a gaseous blowing agent and melted in a conventional extruder to form a solution of blowing agent and molten polymer, which then is extruded into a pressurized mold cavity. The pressure in the mold is maintained above the solubility pressure of the gaseous blowing agent at melt temperatures for given initial saturation. When the molded part temperature drops to the appropriate critical nucleation temperature, the pressure on the mold is dropped, typically to ambient, and the part is allowed to foam.

U.S. Pat. No. 5,158,986 (Cha et al.) describes an alternative molding system and method for producing microcellular parts. Polymeric pellets are introduced into a conventional extruder and melted. A blowing agent of carbon dioxide in its supercritical state is established in the extrusion barrel and mixed to form a homogenous solution of blowing agent and polymeric material. A portion of the extrusion barrel is heated so that as the mixture flows through the barrel, a thermodynamic instability is created, thereby creating sites of nucleation in the molten polymeric material. The nucleated material is extruded into a pressurized mold cavity. Pressure within the mold is maintained by counter pressure of air. Cell growth occurs inside the mold cavity when the mold cavity is expanded and the pressure therein is reduced rapidly; expansion of the mold provides a molded and foamed article having small cell sizes and high cell densities. Nucleation and cell growth occur separately according to the technique; thermally-induced nucleation takes place in the barrel of the extruder, and cell growth takes place in the mold.

Commonly owned U.S. patent application Ser. No. 09/335,946, filed Jun. 18, 1999, entitled INJECTION MOLDING OF POLYMERIC MATERIAL, and incorporated by reference herein, describes a number of injection molding systems and methods capable of forming foam molded articles and foamed materials, both microcellular (as defined by cell size and densities) and non-microcellular. Although the systems and processes described in the above-referenced patent application (hereinafter, the “co-pending application”) can be used to form a wide variety of foam molded articles and foamed materials, the set-up and control of such systems and processes may involve a significant amount of manual intervention, particularly with regard to the formation of microcellular foam molded articles and microcellular foamed materials. Specifically, due to the complex relationship between process parameters, such as the amount of polymeric material to be admixed with an amount of blowing agent, the rate and/or manner in which the polymeric material and the blowing agent are introduced and admixed within a polymer processing space, material solubility limits of the polymeric material and of the blowing agent, the relationship of blowing agent delivery pressure to the melt pressure of the polymeric material within the polymer processing space, etc., and the desired characteristics (e.g., the weight, the void volume, the cell size, the void volume, the density, the tensile strength, etc.) of the foam molded article or foamed material, care must be exercised in the set up and control of such systems and processes to ensure the desired results. Furthermore, even relatively slight changes to one or more of the aforementioned process parameters may require an intimate understanding of how these process parameters affect the characteristics of the foam molded article or foamed material to modify the system or process to achieve the desired results.

### SUMMARY OF THE INVENTION

Embodiments of Applicant's invention provide a system and method for producing foamed products (i.e., foam molded articles and foamed materials) in which a detailed understanding of the complexities involved in producing the foamed products is not required. Further, embodiments of Applicant's invention may be used to form microcellular foamed products (i.e., microcellular foam molded articles and microcellular foamed materials), as defined by cell size and densities, as well as non-microcellular foamed products (i.e., non-microcellular foam molded articles and non-microcellular foamed materials).

According to an aspect of the present invention, an automated system and method is provided for producing foamed products. According to this aspect of the invention, based upon receipt of an input indicative of an amount of a polymeric material to be provided to a polymer processing space of a polymer processing apparatus, an amount of a blowing agent to be admixed therewith to form a foamed product can be determined. Where the foamed product is a microcellular foamed product, the amount of the blowing agent may be determined automatically, without any further input, and a blowing agent delivery system may be automatically configured to provide the determined amount of the blowing agent. Additional inputs may be provided to further control various process parameters, to further control characteristics of the microcellular foamed product formed thereby, or to further control the blowing agent delivery system. Where the foamed product is not a microcellular foamed product, other inputs may be needed to determine the amount of the blowing agent to be admixed therewith. However, upon determining the amount of the blowing agent to be provided to the polymer processing space, the blowing agent delivery may be automatically configured to provide the determined amount of the blowing agent.

According to one embodiment of the present invention, a computer readable medium is provided. The computer readable medium is encoded with a program that, when executed on a polymer processing apparatus controller, performs a method comprising acts of receiving a first input indicative of an amount of a polymeric material to be provided to a polymer processing space of a polymer processing apparatus, and automatically determining an amount of a blowing agent to be provided to the polymer processing space to form a foamed product based upon the amount of polymeric material.

According to another embodiment of the present invention, a method is provided. The method includes acts of receiving a first input indicative of an amount of a polymeric material to be provided to a polymer processing space of a polymer processing apparatus, and automatically configuring, based upon the amount of polymeric material to be provided to the polymer processing space, a blowing agent delivery system to provide an amount of blowing agent to the polymer processing space to form a foamed product.

According to a further embodiment of the present invention, another method is provided. The method includes acts of receiving a first input indicative of an amount of a polymeric material to be provided to a polymer processing space of a polymer processing apparatus, and automatically configuring, based upon the amount of polymeric material to be provided to the polymer processing space, a blowing agent delivery system to provide an amount of blowing agent to the polymer processing space to form a foamed product.

According to a further embodiment of the present invention, a controller for a blowing agent delivery system is provided. The controller includes a first input to receive at least one input signal, a processor that is coupled to the first input, and a first output that is coupled to the processor and a blowing agent delivery system. The at least one input signal includes a first input signal indicative of an amount of a polymeric material to be provided to a polymer processing space of a polymer processing apparatus. The processor determines, based at least upon the first input signal, an amount of a blowing agent to be provided by the blowing agent delivery system to the polymer processing space to form a foamed product. The first output, provides a first output signal to the blowing agent delivery system that automatically configures the blowing agent delivery system to provide the amount of the blowing agent to the polymer processing space.

According to another aspect of the present invention, a method is provided including acts of: (A) providing an amount of polymeric material to a polymer processing space; (B) introducing an amount of a blowing agent to the polymer processing space; and (C) controlling the introduction of the amount of the blowing agent in act (B) to provide a single-phase solution of the polymeric material and the blowing agent within the polymer processing space.

Other advantages, novel features, and objects of the invention will become apparent from the following detailed description of the invention when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

In the drawings:

FIG. 1 illustrates an injection or intrusion molding system that may be used to form foamed products with which embodiments of the present invention may be used;

FIG. 1A illustrates a multi-hole blowing agent feed orifice arrangement and extrusion screw in the system of FIG. 1;

FIG. 2 is a schematic block diagram of a controller according to one embodiment of the present invention that may be used to configure and control polymer processing apparatus;

FIG. 3 illustrates a configuration database that may be accessed by the controller of FIG. 2 to configure and control polymer processing apparatus;

FIG. 4 is a flow diagram illustrating a configuration routine that may be used by the controller of FIG. 2;

FIG. 5 is schematic block diagram of a controller according to another embodiment of the present invention that may be used with an injection/intrusion molding system;

FIG. 6 is a flow diagram illustrating a configuration and control routine that may be used by the controller of FIG. 5; and

FIG. 7 is another flow diagram illustrating a configuration and control routine that may be used by the controller of FIG. 5.

### DETAILED DESCRIPTION OF THE INVENTION

Commonly-owned, co-pending international patent publication nos. WO 98/08667, published Mar. 5, 1998, WO 98/31521, published Jul. 23, 1998, and WO 00/26005, published May 11, 2000, are incorporated herein by reference. Commonly-owned, copending U.S. patent application Ser. no. 08/777,709 entitled METHOD AND APPARATUS FOR MICROCELLULAR POLYMER EXTRUSION, filed Dec. 20, 1996, and commonly-owned, co-pending international patent application no. US/98/27118 entitled MICROCELLULAR FOAM EXTRUSION/BLOW MOLDING PROCESS AND ARTICLE MADE THEREBY, filed Dec. 18, 1998, are also incorporated herein by reference.

The various embodiments and aspects of the invention will be better understood from the following definitions. As used herein, “nucleation” defines a process by which a homogeneous, single-phase solution of polymeric material, in which is dissolved molecules of a species that is a gas under ambient conditions, undergoes formations of clusters of molecules of the species that define “nucleation sites”, from which cells will grow. This definition of “nucleation sites” should not be confused with sites at which nucleating agent (defined below) particles exist. However, under appropriate conditions, sites at which nucleating agent particle exist can become nucleation sites. Nucleation means a change from a homogeneous, single-phase solution to a mixture in which sites of aggregation of at least several molecules of blowing agent are formed. Nucleation defines that transitory state when gas, in solution in a polymer melt, comes out of solution to form a suspension of bubbles within the polymer melt. Generally this transition state is forced to occur by changing the solubility of the polymer melt from a state of sufficient solubility to contain a certain quantity of gas in solution to a state of insufficient solubility to contain that same quantity of gas in solution. Nucleation can be effected by subjecting the homogeneous, single-phase solution to rapid thermodynamic instability, such as rapid temperature change, rapid pressure drop, or both. Rapid pressure drop can be created using a nucleating pathway, defined below. Rapid temperature change can be created using a heated portion of an extruder, a hot glycerin bath, or the like. “Microcellular nucleation,” as used herein, means nucleation at a cell density high enough to create microcellular material upon controlled expansion. As used herein, “nucleation” defines the process by which gas molecules coalesce and eventually form cells, and is not to be confused with nucleation associated with crystallization.

A “nucleating agent” is a dispersed agent, such as talc or other filler particles, added to a polymer and able to promote formation of nucleation sites from a single-phase, homogeneous solution. “Nucleated” refers to a state of a fluid polymeric material that had contained a single-phase, homogeneous solution including a dissolved species that is a gas under ambient conditions, following an event (typically thermodynamic instability) leading to the formation of nucleation sites. “Non-nucleated” refers to a state defined by a homogeneous, single-phase solution of polymeric material and dissolved species that is a gas under ambient conditions, absent nucleation sites. A “non-nucleated” material can include nucleating agent such as talc.

A “polymeric material/blowing agent mixture” can be a single-phase, non-nucleated solution of at least the two, a nucleated solution of at least the two, or a mixture in which blowing agent cells have grown.

“Nucleating pathway” is meant to define a pathway that forms part of microcellular polymeric foam extrusion apparatus and in which, under conditions in which the apparatus is designed to operate (typically at pressures of from about 1500 to about 30,000 psi upstream of the nucleator and at flow rates of greater than about 0.1 pounds polymeric material per hour), the pressure of a single-phase solution of polymeric material admixed with blowing agent in the system drops below the saturation pressure for the particular blowing agent concentration at a rate or rates facilitating rapid nucleation. A nucleating pathway defines, optionally with other nucleating pathways, a nucleation or nucleating region of a device of the invention.

Embodiments of the present invention provide systems and methods for the intrusion and injection molding of polymeric material, including microcellular polymeric material, and systems and methods useful in intrusion and injection molding and also useful in connection with other techniques. For example, although injection and intrusion molding are primarily described, the invention can be readily modified by those of ordinary skill in the art for use in other plastic processing methods such as, without limitation, extrusion, extrusion molding, blow molding, low-pressure molding, co-injection molding, laminar molding, injection compression, and the like.

For purposes of the present invention, microcellular material is defined as foamed material having an average cell size of less than about 100 microns in diameter, or material of cell density of generally greater than at least about 10⁶ cells per cubic centimeter, or preferably both. Non-microcellular foams have cell sizes and cell densities outside of these ranges. The void fraction of microcellular material generally varies from 3% to 98%.

In certain embodiments, microcellular material may be produced having average cell size of less than about 50 microns. In some embodiments where particularly small cell size is desired, the microcellular material may have average cell size of less than about 20 microns, less than about 10 microns, or less than about 5 microns. In certain embodiments, the microcellular material may have a maximum cell size of about 100 microns. Where particularly small cell size is desired, the material can have maximum cell size of about 50 microns, or about 25 microns, or about 15 microns, or about 8 microns, or about 5 microns. Embodiments of the present invention may include all combinations of the above-noted average cell sizes and maximum cell sizes. For example, one embodiment may include microcellular material having an average cell size of less than about 30 microns with a maximum cell size of about 50 microns, and another may include an average cell size of less than about 30 microns with a maximum cell size of about 35 microns, etc. That is, microcellular material designed for a variety of purposes can be produced having a particular combination of average cell size and a maximum cell size preferable for that purpose.

In one embodiment, essentially closed-cell microcellular material can be produced. As used herein, “essentially closed-cell” is meant to define material that, at a thickness of about 100 microns, contains no connected cell pathway through the material.

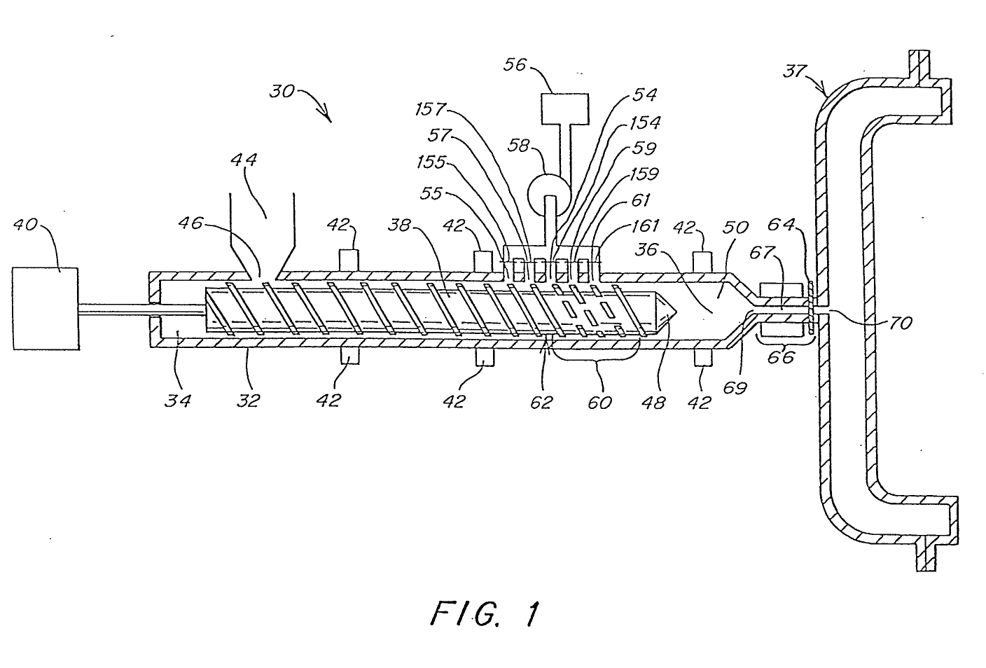

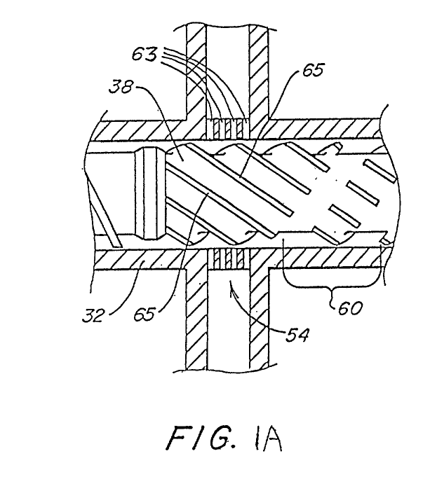

FIG. 1 is an example of a polymer processing apparatus with which embodiments of the present invention may be used to form foamed materials and foam molded articles. The polymer processing apparatus 30 depicted in FIG. 1 is described in the co-pending application as an injection or intrusion molding system that is particularly well suited to forming microcellular foamed materials and microcellular foam molded articles (collectively referred to herein as “microcellular foamed products”). However, it should be appreciated that such a molding system may also be used to form non-microcellular foamed materials and non-microcellular foam molded articles (collectively referred to herein as “non-microcellular foamed products”). Accordingly, although embodiments of the present invention are described with reference to a polymer processing apparatus that is particularly well suited to forming microcellular products, the present invention is not so limited, and may be used with any type of polymer processing apparatus in which a physical blowing agent is used to form a variety of foamed products, including microcellular foamed products as well as non-microcellular foamed products. Further, embodiments of the present invention may be used with a variety of different types of molding systems, including extrusion molding systems, blow molding systems, low-pressure molding systems, laminar molding systems, injection compression molding systems, etc.

As shown in FIG. 1, polymer processing apparatus 30 includes a barrel 32 having a first, upstream end 34, and a second, downstream end 36 connected to a molding chamber 37. Mounted for rotation within barrel 32 is a screw 38 operably connected, at its upstream end, to a drive motor 40. Although not shown in detail, screw 38 includes feed, transition, gas injection, mixing, and metering sections.

Positioned along barrel 32, optionally, are temperature control units 42. Control units 42 can be electrical heaters, can include passageways for temperature control fluid, and/or the like. Units 42 can be used to heat a stream of pelletized or fluid polymeric material within the barrel to facilitate melting, and/or to cool the stream to control viscosity and, in some cases, blowing agent solubility. The temperature control units can operate differently at different locations along the barrel, that is, to heat at one or more locations, and to cool at one or more different locations. Any number of temperature control units can be provided.

Barrel 32 is constructed and arranged to receive a precursor of polymeric material. As used herein, “precursor of polymeric material” is meant to include all materials that are fluid, or can form a fluid and that subsequently can harden to form a polymeric article. Typically, the precursor is defined by thermoplastic polymer pellets, but can include other species. For example, the precursor can be defined by species that will react to form microcellular polymeric material as described, under a variety of conditions. Embodiments of the invention are meant to embrace production of microcellular material from any combination of species that together can react to form a polymer, typically monomers or low-molecular-weight polymeric precursors which are mixed and foamed as the reaction takes place. In general, species embraced by the invention include thermosetting polymers in which a significant increase in molecular weight of the polymer occurs during reaction, and during foaming, due to cross-linking of polymeric components.

Preferably, a thermoplastic polymer or combination of thermoplastic polymers is selected from among amorphous, semicrystalline, and crystalline material including polyolefins such as polyethylene and polypropylene, fluoropolymers, cross-linkable polyolefins, polyamides, polyvinyl chloride, and polyaromatics such as styrenic polymers including polystyrene. Thermoplastic elastomers can be used as well, especially metallocene-catalyzed polyethylene.

Typically, introduction of the precursor of polymeric material utilizes a standard hopper 44 for containing pelletized polymeric material to be fed into the extruder barrel through orifice 46, although a precursor can be a fluid prepolymeric material injected through an orifice and polymerized within the barrel via, for example, auxiliary polymerization agents. In connection with the present invention, it is important only that a fluid stream of polymeric material be established in the polymer processing apparatus.

Immediately downstream of downstream end 48 of screw 38 in FIG. 1 is a region 50 which can be a temperature adjustment and control region, auxiliary mixing region, auxiliary pumping region, or the like. For example, region 50 can include temperature control units to adjust the temperature of a fluid polymeric stream prior to nucleation, as described below. Region 50 can include instead, or in addition, additional, standard mixing units (not shown), or a flow-control unit such as a gear pump (not shown). Alternatively, region 50 can be replaced by a second screw in tandem which can include a cooling region. Where screw 3 8 is a reciprocating screw in an injection molding system, region 50 can define an accumulation region in which a single-phase, non-nucleated solution of polymeric material and a blowing agent is accumulated prior to injection into mold 37.

Along barrel 32 of system 30 is at least one port 54 in fluid communication with a source 56 of a physical blowing agent, that is, a blowing agent that is a gas under ambient conditions (described more fully below). Any of a wide variety of physical blowing agents known to those of ordinary skill in the art such as helium, hydrocarbons, chlorofluorocarbons, nitrogen, carbon dioxide, and the like can be used in connection with the invention, or mixtures thereof, and, according to one embodiment, source 56 may provide carbon dioxide as a blowing agent. Supercritical fluid blowing agents are preferred for the production of microcellular-foamed products, in particular supercritical carbon dioxide. In one embodiment solely supercritical carbon dioxide is used as blowing agent. Supercritical carbon dioxide can be introduced into the extruder and made to form rapidly a single-phase solution with the polymeric material either by injecting carbon dioxide as a supercritical fluid, or injecting carbon dioxide as a gas or liquid and allowing conditions within the extruder to render the carbon dioxide supercritical in many cases within seconds. Injection of carbon dioxide into the extruder in a supercritical state is preferred. The single-phase solution of supercritical carbon dioxide and polymeric material formed in this manner has a very low viscosity which advantageously allows lower temperature molding, as well as rapid filling of molds having close tolerances to form very thin molded parts.

A pressure and metering device 58 typically is provided between blowing agent source 56 and the at least one port 54. As used herein, the term “pressure and/or metering device” is used to indicate that device 58 may control the pressure of the blowing agent or the amount of the blowing agent, or both. Device 58 can be used to meter the mass of the blowing agent between 0.01 lbs/hour and 70 lbs/hour, or between 0.04 lbs/hour and 70 lbs/hour, and more preferably between 0.2 lbs/hour and 12 lbs/hour so as to control the amount of the blowing agent in the polymeric stream within the extruder to maintain blowing agent at a desired level. According to one set of embodiments, the amount, or mass flow rate of blowing agent in the polymeric stream is metered so as to be between about 0.05% and 25% by weight of the mixture of polymeric material and blowing agent, preferably between about 0.1% and 2.0% by weight, more preferably between about 0.2% and 1% by weight, based on the weight of the polymeric stream and blowing agent. The particular blowing agent used (carbon dioxide, nitrogen, etc.) and the amount of blowing agent used is often dependent upon the polymer, the density reduction, cell size and physical properties desired.

The pressure and/or metering device can be connected to a controller (not shown in FIG. 1 but described more fully below) that also is connected to drive motor 40 to control the metering of blowing agent in relationship to the flow of polymeric material to very precisely control the weight percent blowing agent in the fluid polymeric mixture. For example, the mass flow rate of the blowing agent can be controlled so that it varies by no more than +/−0.3% in preferred cases. Alternatively, rather than metering the mass of the blowing agent provided to the at least one port 54, the pressure and metering device 58 may instead meter the volume of the blowing agent that is provided to the at least one port, as described more fully below. Although port 54 can be located at any of a variety of locations along the barrel, it is preferably located just upstream from a mixing section 60 of the screw and at a location 62 of the screw where the screw includes unbroken flights.

Referring now to FIG. 1A, an example of a blowing agent port 54 that may be used with the polymer processing apparatus 30 is illustrated in greater detail and, in addition, two ports on opposing top and bottom sides of the barrel 32 are shown. As shown in FIG. 1A, port 54 is located at a region upstream from mixing section 60 of screw 38 (including highly-broken flights) at a distance upstream of the mixing section of no more than about 4 full flights. Positioned as such, injected blowing agent is very rapidly and evenly mixed into a fluid polymeric stream to quickly produce a single-phase solution of the foamed material precursor and the blowing agent. As illustrated, port 54, may be a multi-hole port including a plurality of orifices 63 connecting the blowing agent source with the extruder barrel 32. As shown, a plurality of ports 54 may be provided about the extruder barrel 32 at various positions radially and can be in alignment longitudinally with each other. For example, a plurality of ports 54 can be placed at the 12 o'clock, 3 o'clock, 6 o'clock, and 9 o'clock positions about the extruder barrel, each including multiple orifices 63.

Also, as shown in FIG. 1A, the blowing agent orifice or orifices can be positioned along the extruder barrel at a location where, when a screw is mounted in the barrel, the orifice or orifices are adjacent full, unbroken flights 65. In this manner, as the screw rotates, each flight, passes, or “wipes” each orifice periodically. This wiping increases rapid mixing of blowing agent and fluid foamed material precursor by essentially rapidly opening and closing each orifice by periodically blocking each orifice, when the flight is large enough relative to the orifice to completely block the orifice when in alignment therewith. The result is a distribution of relatively finely-divided, isolated regions of blowing agent in the fluid polymeric material immediately upon injection and prior to any mixing. In this arrangement, at a standard screw revolution speed of about 30 rpm, each orifice may be passed by a flight at a rate that may vary from at least about 0.5 passes per second to a rate of at least about 2 passes per second. Orifices 54 may be positioned at a distance of from about 15 to about 30 barrel diameters from the beginning of the screw (at upstream end 34).

Downstream of region 50 is a nucleator 66 constructed to include a pressure-drop nucleating pathway 67. As used herein, “nucleating pathway” in the context of rapid pressure drop is meant to define a pathway that forms part of microcellular polymer foam extrusion apparatus and in which, under conditions in which the apparatus is designed to operate (typically at pressures of from about 1500 to about 30,000 psi upstream of the nucleator and at flow rates of greater than about 0.1 lbs polymeric material per hour), the pressure of a single-phase solution of polymeric material admixed with blowing agent in the apparatus drops below the saturation pressure for the particular blowing agent concentration at a rate or rates facilitating nucleation. Nucleating pathway 67 includes an inlet end 69 for receiving a single-phase solution of polymeric material precursor and blowing agent as a fluid polymeric stream, and a nucleated polymer releasing end 70 for delivering nucleated polymeric material to molding chamber, or mold, 37.

Nucleator 66 can be located in a variety of locations downstream of region 50 and upstream of mold 37. For example, nucleator 66 may be located in direct fluid communication with mold 37, such that the nucleator defines a nozzle connecting the extruder to the molding chamber and the nucleated polymer releasing end 70 defines an orifice of molding chamber 37. Moreover, nucleator 66 may include a nucleating pathway 67 constructed and arranged to have a variable cross-sectional dimension, that is, a pathway that can be adjusted in cross-section. A variable cross-section nucleating pathway allows the pressure drop rate in a stream of fluid polymeric material passing therethrough to be varied in order to achieve a desired nucleation density. For example, a nucleating pathway that changes in cross-sectional dimension along its length may be used. In particular, a nucleating pathway that decreases in cross-sectional dimension in a downstream direction can significantly increase pressure drop rate thereby allowing formation of microcellular material of very high cell density using relatively low levels of blowing agent. These and other exemplary and preferred nucleators are described in co-pending U.S. patent application Ser. No. 08/777,709 entitled “Method and Apparatus for Microcellular Extrusion” and international patent application serial no. PCT/US97/15088, entitled “Method and Apparatus for Microcellular Polymer Extrusion” of Anderson, et al.

While pathway 67 defines a nucleating pathway, some nucleation also may take place in the mold itself as pressure on the polymeric material drops at a very high rate during filling of the mold.

The system of FIG. 1 illustrates one general example of a polymer processing apparatus in which a single-phase, non-nucleated solution of polymeric material and blowing agent is nucleated, via rapid pressure drop, while being urged into molding chamber 37 via the rotation action of screw 38. This polymer processing apparatus illustrates an intrusion molding technique and, in this type of apparatus, only one blowing agent injection port 54 need be utilized.

Alternatively, screw 38 of polymer processing apparatus 30 may be a reciprocating screw and the apparatus 30 may define an injection molding system. For example, screw 38 may be mounted for reciprocation within barrel 32, and the system may include a plurality of blowing agent inlets or injection ports 54, 55, 57, 59, and 61 arranged axially along barrel 32 and each connecting barrel 32 fluidly to pressure and/or metering device 58 and a blowing agent source 56. Each of injection ports 54, 55, 57, 59, and 61 can include a mechanical shut-off valve 154, 155, 157, 159, and 161 respectively, which allow the flow of blowing agent into extruder barrel 38 to be controlled as a function of axial position of reciprocating screw 38 within the barrel. In operation, a charge of fluid polymeric material and blowing agent (which can be a single-phase, non-nucleated charge in some embodiments) is accumulated in region 50 downstream of the downstream end 48 of screw 38. Screw 38 is forced distally (downstream) in barrel 32 causing the charge in region 50 to be injected into mold 37. A mechanical shut-off valve 64, located near orifice 70 of mold 37, then can be closed and mold 37 can be opened to release an injection-molded part. Screw 38 then rotates while retracting proximally (toward the upstream end 34 of the barrel), and shut-off valve 161 is opened while shut-off valves 155, 157, 154, and 159 all are closed, allowing blowing agent to be injected into the barrel through distal-most port 61 only. As the barrel retracts while rotating, shut-off valve 161 is closed while shut-off valve 159 is opened, then valve 159 is closed while valve 154 is opened, etc. That is, the shut-off valves which control injection of blowing agent from source 56 into barrel 32 are controlled so that the location of injection of blowing agent moves proximally (in an upstream direction) along the barrel as screw 38 retracts proximally. The result is injection of blowing agent at a position along screw 38 that remains essentially constant. Thus, blowing agent is added to fluid polymeric material and mixed with the polymeric material to a degree and for a period of time that is consistent independent of the position of screw 38 within the barrel. Toward this end, more than one of shut-off valves 155, 157, etc. can be open or at least partially open simultaneously to achieve smooth transition between injection ports that are open and to maintain essentially constant location of injection of blowing agent along barrel 38.

Once barrel 38 is fully retracted (with blowing agent having been most recently introduced through injection port 55 only), all of the blowing agent shut-off valves are closed. At this point, within distal region 50 of the barrel is an essentially uniform fluid polymeric material/blowing agent mixture. Shut-off valve 64 then is opened and screw 38 is urged distally to inject the charge of polymeric material and blowing agent into mold 37.

The above-described polymer processing apparatus involving a reciprocating screw can be used to produce non-microcellular foam or microcellular foam. Where non-microcellular foam is to be produced, the charge that is accumulated in distal region 50 can be a multi-phase mixture including cells of blowing agent in polymeric material, at a relatively low pressure. Injection of such a mixture into mold 37 results in cell growth and production of conventional foam. Where microcellular material is to be produced, a single-phase, non-nucleated solution is accumulated in region 50 and is injected into mold 37 while nucleation takes place.

The described arrangement facilitates a method in which varying concentrations of blowing agent in fluid polymeric material is created at different locations in a charge accumulated in distal portion 50 of the barrel. This can be achieved by control of shut-off valves 155, 157, 154, 159, and 161 in order to achieve non-uniform blowing agent concentration. In this technique, articles having varying densities may be produced, such as, for example, an article having a solid exterior and a foamed interior.

Although not shown, molding chamber 37 can include vents to allow air within the mold to escape during injection. The vents can be sized to provide sufficient back pressure during injection to control cell growth so that uniform microcellular foaming occurs. Alternatively, a single-phase, non-nucleated solution of polymeric material and blowing agent can be nucleated while being introduced into an open mold, then the mold can be closed to shape a microcellular article.

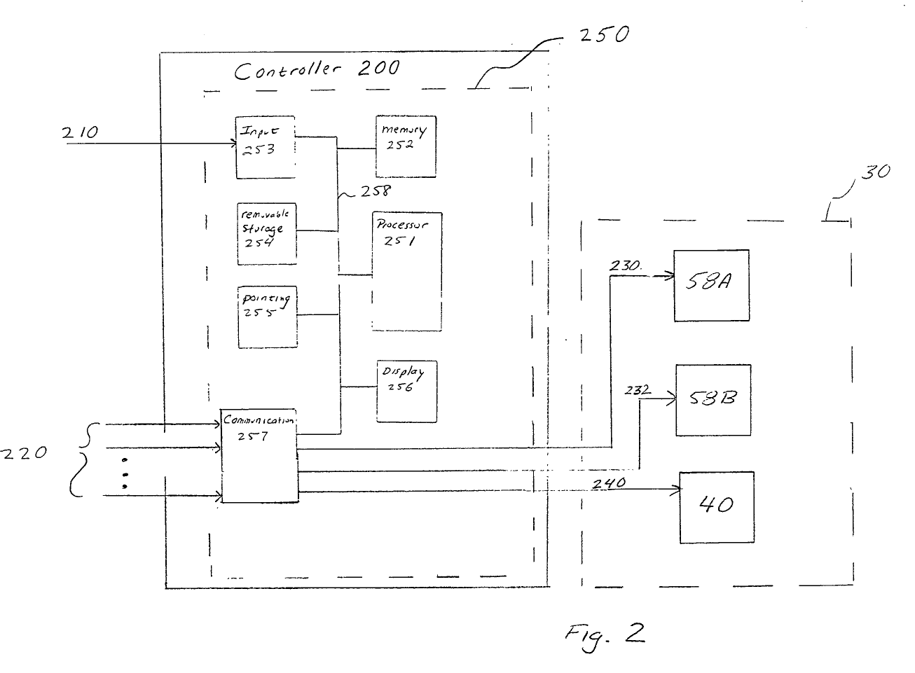

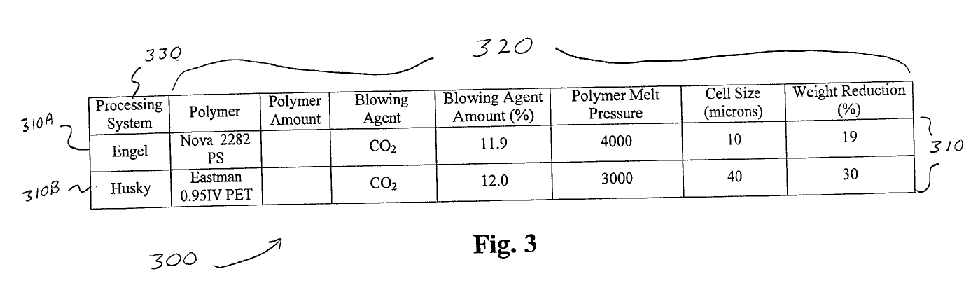

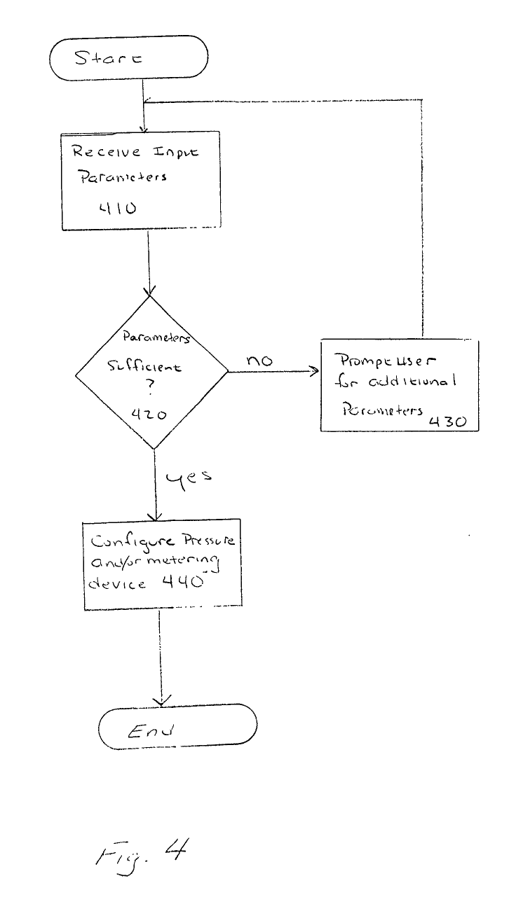

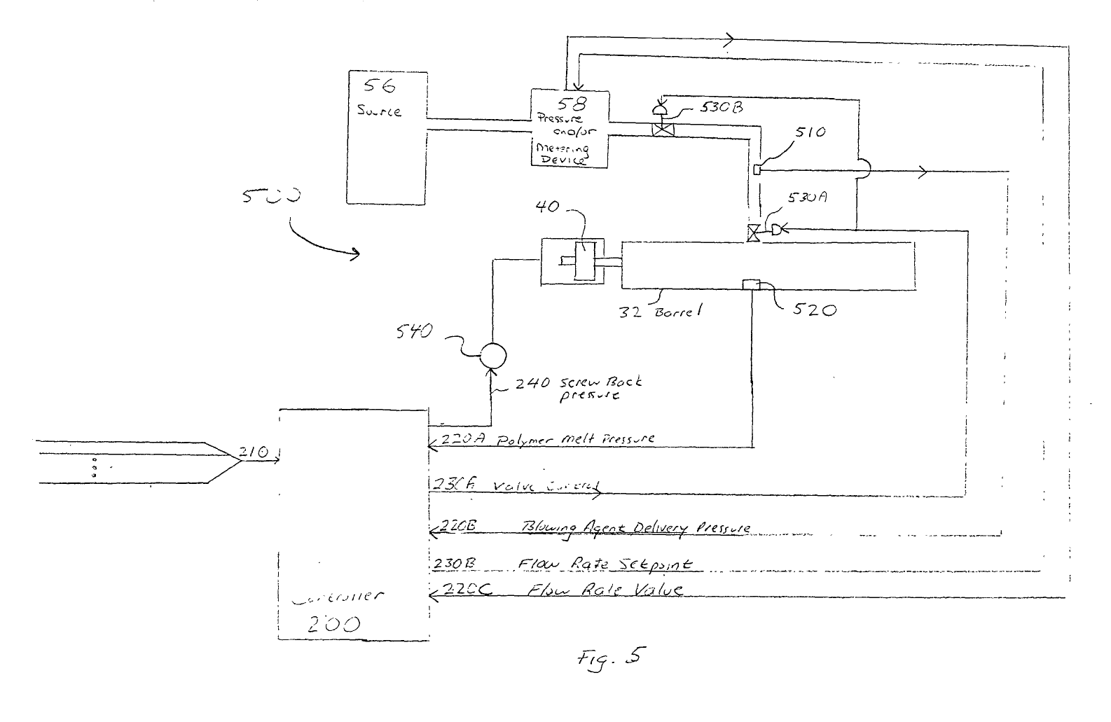

As described in the co-pending application, a number of alterations may be made to the polymer processing apparatus of FIG. 1 to produce a wide variety of foamed products, both microcellular and non-microcellular. For example, as described with respect to FIG. 2 of the co-pending application, one or more accumulators may be provided for accumulating molten polymeric material prior to injection into a molding chamber, and a variety of molding chambers may also be used, as described in FIGS. 3-4. Moreover, the polymer processing apparatus of FIG. 1 may be adapted as described in FIGS. 5-8 of the co-pending application to provide foamed products having a variable density, for example, a microcellular product having an essentially solid exterior wall and a foamed interior. Alternatively, the techniques described in the co-pending application may also be used also in gas-assist co-injection wherein a precursor of microcellular material is extruded and nucleated while being introduced into a mold, while gas is injected into the melt stream in such a way as to form, in the mold, an exterior layer against the mold walls of nucleated polymeric material and a central void filled with the co-injected gas.

Although a wide variety of foamed products may be produced using polymer processing apparatus such as that described in the co-pending application, the set-up and control of such systems may involve a significant amount of manual intervention, particularly with regard to the production of microcellular foamed products. For example, to modify a conventional polymer processing apparatus that produces a solid product to produce a microcellular foamed product requires a knowledge of the amount of polymeric material that is to be admixed with an amount of blowing agent, the rate and/or manner in which the polymeric material and the blowing agent are to be introduced and admixed within a polymer processing space of the polymer processing apparatus, material solubility limits of the polymeric material and of the blowing agent, the pressure at which the blowing agent is introduced to the polymeric material, the temperature of the polymeric material, etc. In this regard, a detailed understanding of how variations in these parameters can affect characteristics of the foamed product produced thereby, in terms of cell size, void volume, tensile strength, opacity, surface finish, etc. is typically necessary to determine whether the desired foamed product can be produced. Furthermore, a detailed understanding of the complex relationship amongst these input parameters relative to the characteristics of the foamed product produced thereby is typically needed to modify the system to accommodate changes to one or more of the input parameters, as even slight variations in one or more of the input parameters can dramatically affect the characteristics of the foamed product.

According to one aspect of the present invention, a polymer processing apparatus controller is provided that overcomes the aforementioned difficulties. In one embodiment, the polymer processing apparatus controller automatically configures a blowing agent delivery system to provide an appropriate amount of blowing agent to form a microcellular product. In other embodiments, in addition to configuring the blowing agent delivery system, the controller controls the polymer processing apparatus to produce a microcellular foamed product. As used herein, the term “automatically” means without any further input required by a user of the blowing agent delivery system.

FIG. 2 is a schematic block diagram of a polymer processing apparatus controller according to one aspect of the present invention. In the exemplary embodiment illustrated in FIG. 2, the polymer processing apparatus controller 200 is implemented on a conventional personal computer 250 that includes a processor 251, a memory 252, an input device 253, optionally a removable storage device 254, a pointing device 255, a display device 256, and a communication device 257, all coupled together via a bus 258. In a conventional manner, memory 252 may include a variety of memory devices, such as hard disk drives or optical disk drives, RAM, ROM, or other memory devices and combinations thereof, and input device 253 may include a keyboard, a microphone, or any other form of input device capable of receiving one or more inputs 210 from a user of the polymer processing apparatus controller 200. Removable storage device 254 may include a CD-ROM drive, a tape drive, a diskette drive, etc. and may be used to load application software, including software to implement various embodiments of the present invention described herein. Display 256 may include a conventional CRT display screen, a flat panel display screen, or any other type of display device that allows textual information to be displayed to the user, and pointing device 255 may include a puck, a joystick, a trackball, a mouse, or any other type of pointing device or scrolling device that permits the user to select from among the various textual information displayed on the display device 256. Communication device 257 may include any form of communication transceiver capable of receiving one or more inputs 220 from the polymer processing apparatus 30 and providing one or more outputs to the polymer processing apparatus 30. For example, communication device 257 may include a RS232/485 communication transceiver, a 4-20 mA analog transceiver, an ethernet transceiver, etc.

Software, including code that implements embodiments of the present invention, may be stored on some type of removable storage media such as a CD-ROM, tape, or diskette, or other computer readable medium appropriate for the implemented memory 252 and the removable storage device 254. The software can be copied to a permanent form of storage media on the computer 250 (e.g., a hard disk) to preserve the removable storage media for back-up purposes. It should be appreciated that in use, the software is generally and at least partially stored in RAM, and is executed on the processor 251.

Various embodiments of the present invention can also be implemented exclusively in hardware, or in a combination of software and hardware. For example, in one embodiment, rather than a conventional personal computer, a Programmable Logic Controller (PLC) is used. As known to those skilled in the art, PLCs are frequently used in a variety of process control applications where the expense of a general purpose computer is unnecessary. PLCs may be configured in a known manner to execute one or a variety of control programs, and are capable of receiving inputs from a user or another device and/or providing outputs to a user or another device, in a manner similar to that of a personal computer. Accordingly, although embodiments of the present invention are described in terms of a general purpose computer, it should be appreciated that the use of a general purpose computer is exemplary only, as other configurations may be used.

As shown in FIG. 2, the controller 200 is adapted to be coupled to a polymer processing apparatus, such as the polymer processing apparatus 30 shown in FIG. 1, to control operation of the polymer processing apparatus. Controller 200 includes an input 210 to receive one or more parameters from a user of the controller 200 relating to the desired operation of the polymer processing apparatus. The controller 200 also includes a plurality of inputs 220 to receive signals relating to the operational status of the polymer processing apparatus, and a plurality of outputs 230, 240 to configure and control the polymer processing apparatus. User input parameters received on input 210 may include the type and amount of polymeric material that is to be provided to the polymer processing space (e.g., barrel 32 in FIGS. 1 and 1A), the type and amount of blowing agent to be admixed within the polymer processing space, the desired melt pressure of the polymeric material within the polymer processing space, the pressure of the blowing agent introduced to the polymer processing space, etc.

According to one embodiment of the present invention, described in detail further below, the amount of polymeric material that is to be provided to the polymer processing space may be specified by a user in a variety of ways. These include specifying the mass amount of polymeric material provided to the barrel 32 over time, specifying the mass amount of polymeric material in the foamed product, specifying the mass amount of polymeric material (including runners) in a charge or shot of admixed polymeric material and blowing agent (e.g., for discontinuous forms of molding, such as injection molding), specifying the volume amount of polymeric material that is to be provided to the polymer processing space or to a mold (e.g., mold 37 in FIG. 1) over time, or in a charge or shot of admixed polymeric material and blowing agent, or by specifying an amount of polymeric material in a solid product for which a similarly dimensioned foamed product is desired (e.g., where polymer processing apparatus previously used to produce the solid product has been modified to produce a similarly dimensioned foamed product). Where the position of the extrusion or plasticating screw remains constant, the speed of rotation of the screw (i.e., screw speed) can also be used to determine the rate of polymeric material being provided to the polymer processing space.

Similarly, the amount of blowing agent that is to be admixed with the amount of polymeric material may be specified by a user in a variety of ways, including by specifying the mass of blowing agent introduced to the polymeric material over time, by specifying the mass of blowing agent in the foamed product, by specifying the mass amount of polymeric material (including runners) in a charge or shot of admixed polymeric material and blowing agent, and/or by specifying the mass or mass percentage of blowing agent in the foamed product. In certain embodiments, the amount of blowing agent may also be specified indirectly, such as by specifying a desired weight reduction in the foamed product relative to the solid product, a desired density of the foamed product, a desired average cell size or void volume of the foamed product, etc. Furthermore, depending upon the particulars of the polymer processing apparatus, additional input parameters may also be specified, including specifying conditions relating to how and when the blowing agent is introduced into the polymeric material, based upon cycle time, based upon screw position, etc.

Embodiments of the present invention permit the user to specify one or a number of input parameters relating to the operation of the polymer processing apparatus, and then, based upon the input parameters, to configure and control the polymer processing apparatus to produce a foamed product. Depending upon the number of input parameters specified by the user, the controller may prompt the user for additional parameters prior to configuring the polymer processing apparatus.

Inputs 220 of controller 200 are adapted to receive a plurality of signals relating to the operational status of the polymer processing apparatus. Signals that may be received on inputs 220 generally correspond to physical conditions within the polymer processing apparatus, and may include, for example, the melt pressure of the polymeric material within the polymer processing space, the pressure of the blowing agent, the temperature of the polymer within the polymer processing space, screw position, screw recovery time, etc.

Outputs 230, 240 of the controller 200 are adapted to configure and control the polymer processing apparatus, based upon the user parameters received at input 210, and optionally, one or more of the signals received on inputs 220. At least one output 230 is provided that is operatively coupled to a pressure and/or metering device 58 (shown in FIG. 1) to configure and control the amount, and optionally the pressure, of the blowing agent provided to the polymer processing space of the polymer processing apparatus. Output 230 may provide a number of separate signals, for example, a signal for setting a flow rate of the blowing agent from a blowing agent source (e.g., source 56 in FIG. 1), a signal for setting the desired delivery pressure of the blowing agent, and one or more signals for controlling injector valves (e.g., valves 154, 155, etc. in FIG. 1) that control delivery of the blowing agent to the polymer processing space, or may provide a single multiplexed signal that include one or more of the afore-mentioned signals. In the embodiment shown in FIG. 2, two outputs 230, 232 are provided, each being coupled to a respective pressure and/or metering device 58A, 58B. The embodiment illustrated in FIG. 2 thus permits the separate configuration and control of multiple pressure and/or metering devices, such as may be used with multiple injector systems. Alternatively, where a single pressure and/or metering device 58 is capable of controlling multiple injectors, or where only a single injector or other type of blowing agent delivery device is used, only a single output 230 may be provided.

Controller 200 may also include a second output 240 that controls the pressure of the melted polymeric material within the polymer processing space. For example, where the polymer processing apparatus is an injection or intrusion molding system, output 240 may be coupled to a hydraulic back pressure regulator (shown in FIG. 5) that controls the back pressure acting against screw reciprocation to accurately set and control the melt pressure of the polymeric material within the polymer processing space. As should be appreciated by those skilled in the art, control of the melt pressure of the polymeric material within the polymer processing space may be desired to ensure that the foamed product possesses the desired characteristics. Moreover, in those embodiments directed to the production of microcellular foamed products, control of the both the melt pressure of the polymeric material and the pressure and/or metering device can be used to ensure that the blowing agent is introduced to the polymer processing space at a pressure that is greater than the melt pressure of the polymeric material to minimize a surge of the blowing agent into the polymeric material.

According to an aspect of the present invention, controller 200 may include a database that can be accessed by the processor 251 and used to configure and/or control the polymer processing apparatus. According to one embodiment of the present invention, the database may include a plurality of records, each record corresponding to a particular set of parameters for which the polymer processing apparatus may be used to produce a foamed product. Unless specifically indicated otherwise, as used hereinafter, the term “parameters” is used to refer to both process parameters (e.g., the mass amount of polymeric material to be provided to the polymer processing space, the mass amount of blowing agent to be admixed therewith, etc.), as well as characteristics (e.g., density, cell size, void volume, etc.) of the foamed product that is desired to be produced given a particular set of process parameters. In general, each of the records stored in the database reflects empirical data based upon use of the polymer processing apparatus under defined conditions, or the use of similar polymer processing apparatus under defined conditions. Examples of process parameter values and product characteristics that may be used to build the database are provided in the aforementioned co-pending application. The controller 200 and the database may thus be viewed as forming an “expert system” that is specifically adapted to producing foamed products. The database may be stored on a removable storage medium and copied to memory 252 for use by the processor 251, or alternatively, the controller may be pre-configured to include the database.

As will be described further below, the database may be configured for a particular type of polymer processing apparatus (e.g., a specific model from a particular manufacturer of polymer processing apparatus), or may be configured to be used with a variety of types of polymer processing apparatus (e.g., a number of different models from one or a number of manufacturers of polymer processing apparatus). Moreover, the database may be configured for a particular type of polymeric material (e.g., polystyrene) and/or a particular type or amount of blowing agent (e.g., carbon dioxide). Alternatively, a more general database may be used that includes a number of different polymeric materials and different blowing agents with which a variety of different polymer processing apparatus may be used. In use, the database may be accessed by a polymer processing apparatus configuration and control routine (described in detail below) that is performed by the controller 200 to configure and control the polymer processing apparatus that is operatively coupled thereto. It should be appreciated that while the database is initially based on empirical data obtained with similar equipment, the database may be periodically updated (e.g., new records may be added and/or existing records may be modified) to reflect additional data obtained in use, or by use of similar equipment.

FIG. 3 is an exemplary illustration of a configuration database that may be used to configure and/or control a polymer processing apparatus according to one embodiment of the present invention. As shown in FIG. 3, database 300 includes a plurality of records 310, each including a plurality of fields 320. Each of the plurality of records 310A, 310B corresponds to a set of parameters that may be used with polymer processing apparatus to produce a foamed product, and may include process parameters (e.g., polymer type, polymer amount, polymer melt pressure, blowing agent type, blowing agent amount, etc.) as well as product characteristics (cell size, density, tensile strength, etc.) of the foamed product that can be produced given those process parameters. In the exemplary database shown in FIG. 3, each record 310A, 310B is indexed by an identifier 330 indicative of the type of polymer processing apparatus to which the record pertains. For example, the identifier 330 may include the manufacturer and model number of the polymer processing apparatus, and any other relevant information corresponding to the constituent parts thereof (e.g., the size of the plasticizer, the diameter of the plunger, etc.) that uniquely identify the polymer processing apparatus. Where the database 300 is configured for a particular type of polymer processing apparatus (e.g., a specific manufacturer and model number), the database need not include an index 330.

As shown in FIG. 3, fields 320 that can be included in the database may include the type of the polymer (e.g., polystyrene, polyethylene terephthalate, polypropylene, etc.), the amount of the polymer (by mass or weight, by volume, etc.), the type of the blowing agent (carbon dioxide, nitrogen, helium, etc.), the amount of the blowing agent to be admixed with the amount of the polymer (by mass or by mass or weight percentage), the polymer melt pressure, the injection speed (where applicable), the cell size (average, maximum, etc), the weight reduction of the foamed product relative to a similarly dimensioned solid product produced by the same apparatus, the density of the foamed product, the void volume, as well as other process parameters and characteristics. Any one or more of these fields may be used by the polymer apparatus controller to configure the polymer processing apparatus to produce the desired foamed product. Although certain fields shown in FIG. 3 are specified in terms of a particular unit of measure, it should be appreciated that the present invention is not so limited, as any particular field may be specified in a variety of ways. Moreover, as will be described further below, each field may be expressed as a range of values (e.g., with a maximum value and a minimum value), or may include each value within a range of values for which the polymer processing apparatus may be used to form a foamed product having the desired characteristics.

FIG. 4 is an exemplary flow diagram of a configuration routine according to one embodiment of the present invention that may be performed by the polymer processing apparatus controller 200 (FIG. 2) to configure a polymer processing apparatus to produce a foamed product. The configuration routine may be executed by a processor (e.g., processor 251 of personal computer 250 in FIG. 2) or by a PLC to configure a variety of different types of polymer processing apparatus, including injection and intrusion molding systems, extrusion systems, extrusion molding systems, blow molding systems, low pressure molding systems, etc.

At step 410, the configuration routine receives one or more user input parameters (process parameters and/or product characteristics) relating to the foamed product being produced. Depending upon the polymer processing apparatus for which the controller is being used, the routine may prompt the user for a particular parameter, for example, an amount of polymeric material or a desired cell size, or for a plurality of parameters. For example, a number of parameters (e.g., the amount of polymeric material, the amount of blowing agent, the polymer melt pressure, cell size, density, etc.) may be displayed to the user on the display device 256, with the user manipulating the pointing device 255 (or a scrolling device of a PLC) to select a particular parameter, and then using the input device 253 (e.g., keyboard) to provide a particular value for the selected parameter. After providing one or a number of parameter values, the user can submit the input values to the configuration routine, for example, by hitting the enter or return key on the keyboard. It should be appreciated that in those embodiments directed to a particular type of polymer processing apparatus being used to produce a particular product, many of the parameters may be preconfigured, such that only a limited amount of input is required by the user. After receiving one or more parameters from the user, the routine proceeds to step 420.

At step 420, a determination is made as to whether the parameters submitted by the user are sufficient to configure the pressure and/or metering device (e.g., pressure and/or metering device 58 in FIG. 1) to provide an appropriate amount of blowing agent to form the desired product. The determination of whether the parameters submitted by the user are sufficient to configure the pressure and/or metering device can vary depending upon the type of polymer processing apparatus and the foamed product being produced. For example, where the routine is being performed by a controller that has been specifically configured for use with a particular type of polymer processing apparatus and a particular type and amount of polymeric material, such that a number of process parameters and/or characteristics are known to the controller, the routine may simply verify that the parameter values received at step 410 are within an allowable range of values for the foamed product being produced. This may be performed, for example, by accessing a lookup table stored in a memory (e.g., memory 252 in FIG. 2) of the controller 200 that stores a range of allowable values for the parameters (process parameters and/or characteristics) being specified. For example, where only a single process parameter (e.g., the amount of blowing agent) is needed, the routine can simply verify that the process parameter value is within the allowed range, and then proceed to step 440. Alternatively, where a number of process parameters or characteristics are needed (e.g., the amount of polymer and the amount of blowing agent) and fewer than that number have been specified, the routine can proceed to step 430, wherein the user is prompted to provide values for the parameters remaining to be specified. After prompting the user for additional parameter values, the routine returns to step 410.

According to one embodiment of the present invention, a database similar to database 300 described above may be accessed for the determination performed at step 420. According to this embodiment, after one or a number of process parameters and/or characteristics are received at step 410, the controller queries the database to select all records that include the specified process parameter and/or characteristic values, or that include a range of process parameter and/or characteristic values that include the specified process parameter and/or characteristic values. Where the database query returns a single record, such that values for all relevant process parameters are identified, the routine proceeds to step 440. Alternatively, where the database query returns more than one record, such that values for each of the relevant process parameters are not identified, the routine proceeds to step 430, wherein the user is prompted to provide values for the parameters remaining to be specified. This may be performed by displaying the possible process parameter values and requesting a selection, by prompting the user for a particular process parameter value, or in any other suitable manner.

At step 440, the configuration routine configures the pressure and/or metering device to provide the appropriate amount of blowing agent needed to produce the desired foamed product. As will be described further in detail below, the configuration of the pressure and metering device performed at step 440 may include configuring the pressure and/or metering device to provide the blowing agent to the polymer processing space at a particular pressure, and to provide a particular amount of blowing agent to the polymer processing space, for example, to provide a particular mass flow rate of blowing agent to the polymer processing space. Additional steps may be performed to control the polymer processing apparatus, such as to control valve opening for one or a plurality of valves (e.g., valves 154, 155, 157, 159, and 161 in FIG. 1), including the amount of time each valve is open, conditions for valve opening (e.g., based upon polymer melt pressure, based upon polymer volume, based upon screw position, etc.) as described in detail further below. After configuring the pressure and metering device, the routine then terminates.

FIG. 5 is a more detailed schematic diagram of a polymer processing apparatus controller 200 that may be used with an injection or intrusion molding system 500 to configure and control the injection or intrusion molding system and form a variety of foamed products, including microcellular foamed products. It should be appreciated that the injection or intrusion molding system illustrated in FIG. 5 is exemplary only, and that controller 200 may be used with other types of polymer processing apparatus. According to one embodiment of the present invention in which the controller 200 is used to produce a microcellular foamed product, the controller 200 includes an input 210 to receive one or more parameters from a user of the molding system 500, a plurality of outputs 230A, 230B, 240 to configure the molding system to produce the microcellular product, and a plurality of inputs 220A, 220B, 220C to receive signals corresponding to the operational status of the molding system to control the molding system in producing the microcellular product.

Input 210 may be used to receive a variety of user inputs, for example, an input corresponding to an amount of polymeric material to be provided to the polymer processing space (e.g., barrel 32) of the molding system 500. As will be described in further detail below, the amount of polymeric material may be specified by a user in a variety of ways, including by specifying the mass amount of polymeric material to be provided to the polymer processing space of the molding system, by specifying the volume amount of polymeric material to be provided to the polymer processing space, by specifying the amount of polymeric material in a solid product, etc. Input 210 may also be used to receive other user inputs relating to the polymer melt pressure, the amount of blowing agent to be provided to the polymer processing space, and conditions relating to the time and manner in which the blowing agent is introduced to the polymeric material within the polymer processing space.

Controller 200 also includes a plurality of inputs 220 relating to the operational status of the molding system 500 that permit the controller 200 to control the molding system during operation. For example, input 220A is coupled to a pressure transducer 520 that is mounted within the polymer processing space (e.g., barrel 32) of the molding system to accurately monitor the pressure of the polymeric material within the polymer processing space. Preferably, the pressure transducer 520 is located within the polymer processing space in a location proximate to where the blowing agent is introduced. Input 220B is coupled to another pressure transducer 510 that is located within the associated tubing that provides the blowing agent to the polymer processing space. Preferably, pressure transducer 510 is positioned just upstream of the region of the polymer processing space where the blowing agent is introduced to monitor the pressure at which the blowing agent is provided. The described placement of transducers 510, 520 ensures that the pressure of the blowing agent and of the molten polymeric material (i.e., the polymer melt) are known in the region of the polymer processing space in which they are introduced.

The controller 200 may also include a third input 220C corresponding to the mass flow rate of blowing agent being provided by the pressuring and/or metering device 58. For example, pressure and/or metering device 58 may include a mass flow controller that measures and controls the mass flow rate of blowing agent delivered from the source of blowing agent 56 to the polymer processing space. It should be appreciated that the source of blowing agent 56 will typically include other equipment, such as pumps, regulators, valves, etc. to provide an amount and pressure of blowing agent that is suitable for use by the pressure and metering device 58. Such equipment is well known in the art, is therefore not depicted in FIG. 5. It should be appreciated that a number of other inputs 200 relating to the operational status of the molding system 500 may also be provided, such as inputs relating to screw position, screw recovery time, etc.

Controller 200 also includes a plurality of outputs to configure and control the molding system 500. In the illustrated embodiment, outputs from the controller 200 include outputs 230A, 230B and 240. Output 230A is coupled to a shutoff valve 530A that turns on and off the flow of the blowing agent being introduced to the polymer processing space. In one exemplary embodiment, output 230A may also be coupled to a second valve 530B, that operates in conjunction with shutoff valve 530A to regulate the pressure of the blowing agent provided to the polymer processing space. It should be appreciated that where the molding system includes multiple shutoff valves (e.g., shutoff valve 155, 157, 154, 159, and 161 in FIG. 1), multiple output signals may be provided to individually control each shutoff valve, or alternatively, each valve may be controlled by the same output signal.

Output 230B is coupled to the pressure and/or metering device 58 and may be used to control the amount of blowing agent provided by the pressure and/or metering device 58. For example, where the pressure and/or metering device includes a mass flow controller, output 230B can be used to control the mass flow rate of blowing agent that provided by the device to the polymer processing space. Output 230B may also control the pressure at which the blowing agent is provided to the polymer processing space.

The controller 200 also includes an output 240 that is coupled to a back pressure regulator 540 that may be used to control the back pressure acting against screw reciprocation, thereby controlling the melt pressure of the polymeric material within the polymer processing space. For example, the back pressure regulator may be coupled to a hydraulic cylinder (not shown) in a conventional manner for this purpose.

According to an embodiment of the present invention, the controller 200 may be configured to set the delivery back pressure of the blowing agent delivered to the polymer processing space at a value approximately 50-100 psi above the melt pressure of the polymeric material. By setting the blowing agent pressure above the melt pressure of the polymeric material, as the shutoff valve 530A is opened, the surge of the blowing agent into the polymeric material within the polymer processing space is minimized, thereby avoiding sudden changes in viscosity of the admixture within the polymer processing space which can lead to an uncontrolled process and/or undesirable product. Minimizing blowing agent surge is particularly significant with respect to microcellular polymeric material. The setting of the pressure of the blowing agent above the melt pressure of the polymeric material is facilitated by pressure transducers 510 and 520, which provide the controller 200 with the actual values of these parameters. As noted above, while the present invention is not limited in this respect, pressure transducer 510 is preferably disposed in a location immediately upstream of the area of blowing agent introduction, and transducer 520 is preferably disposed within the polymer processing space in a location adjacent to the area of blowing agent introduction.

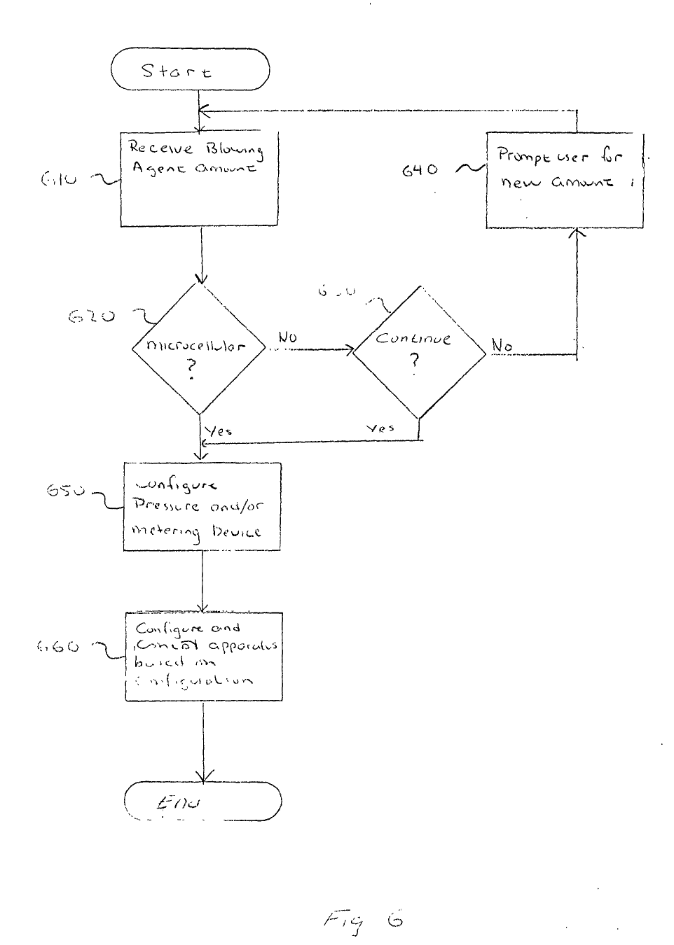

FIG. 6 is an exemplary flow diagram of a configuration and control routine according to one embodiment of the present invention that may be performed by the polymer processing apparatus controller 200 of FIG. 5 to produce a foamed product. In this illustrative example, the configuration and control routine is adapted to produce a microcellular product using a particular type of polymer processing apparatus, such as the injection/intrusion molding system described with respect to FIG. 1, in which certain parameters, such as the type of polymeric material, the volume of the polymer processing space, the type of blowing agent to be used to produce the microcellular product, and the screw recovery time are predefined. Such a configuration is relatively common in the polymer processing industry, as microcellular foam production techniques are frequently used to convert existing solid product polymer processing equipment to be capable of forming microcellular foam products using the existing polymer processing equipment. For example, an injection/intrusion molding system similar to that shown in FIG. 1 may have previously been used to produce a solid product, and then the system modified to produce a microcellular foamed product having the same dimensions. In such an example, most of the process parameters, such as the type of polymeric material being used, the volume of polymeric material in a solid charge or shot, the screw recovery time, etc. are known in advance, and the database (e.g., database 300 in FIG. 3) that is accessed by the controller 200 may be pre-configured to include a number of records, each corresponding to a microcellular product formed using process parameter values corresponding to the intended system and process.

At step 610 the configuration and control routine receives an input from the user specifying the amount of blowing agent to be used in forming the foamed product. As discussed with respect to FIG. 4, the routine may prompt the user to specify the amount of blowing agent in a particular manner. Although the amount of blowing may be specified in a number of different ways, for example, as a weight or mass percentage of the amount of polymeric material in a charge or shot, as a weight or mass amount, etc., the amount of blowing agent is frequently specified in terms of the weight percentage of the amount of polymeric material in a charge or shot. Accordingly, in the exemplary configuration and control routine of FIG. 6, it is assumed that the amount of blowing agent is specified as a mass or weight percentage of the amount of polymeric material in a charge or shot, although as described further below, the present invention is not so limited. After receiving the amount of blowing agent at step 610, the configuration and control routine proceeds to step 620.

At step 620 the configuration and control routine determines whether a microcellular foamed product can be produced given the amount of blowing agent specified by the user at step 610 and the other process parameters for which the controller 200 has been preconfigured. According to one embodiment of the present invention, this determination may be made by querying the preconfigured database in a manner similar to that described with respect to FIG. 3 and selecting all records that include the specified blowing agent amount, or that include a range of blowing agent amounts that include the specified blowing agent amount. Where the database query returns a single record or a number of records that correspond to a microcellular foamed product, the controller determines that a microcellular product can be produced and the routine proceeds to step 650. Where the database query returns no records, the controller determines that a microcellular product cannot be produced and the routine proceeds to step 630.

Where the database query returns a single record, the routine may prompt the user to confirm their selection prior to proceeding to step 650. For example, the routine may display the process parameter values and product characteristics corresponding to the selected record, and request that the user confirm this selection, prior to proceeding to step 650. As the confirmation of the user's selection is optional, this step is not depicted in FIG. 6. Alternatively, where the database query returns more than one record, the routine may simply select a single record according to any suitable method. For example, where a number of records are selected from the database, the routine may select the first record, returned, the last record returned, or a record returned therebetween (e.g., the middle record where an odd number of records are returned). The configuration routine may again prompt the user to confirm the selection in the manner described above prior to preceding to step 650, or where the number of records returned is limited in number, may display each of the records, and request that one be selected, the routine then proceeding to step 650.

Alternatively where the database query returns no records, such that it is determined that a microcellular product cannot be produced, the routine proceeds to step 630. At step 630 a determination is made whether to continue configuring the polymer processing apparatus despite the fact that a microcellular product may not be produced. The determination that is made at step 630 is based upon input received from the user, for example, in response to a prompt from the controller. It should be appreciated that because the polymer processing apparatus may be used to produce microcellular foamed products as well as other types of foamed products, the user may desire to continue configuring the polymer processing apparatus to produce the specified foamed product, despite the fact that the foamed product produce thereby may not be microcellular. Alternatively, because the records stored in the database may not be complete (e.g., the records may be based upon empirical data obtained using similar, but not identical polymer processing equipment, the data may be outdated, the user may have some specialized knowledge not reflected in the database, etc.), the user is provided the opportunity to continue the configuration. It should be appreciated that to aid the user in determining whether to continue, the routine may display the product characteristics of the foamed product that is expected to be produced (e.g., cell size, density, etc.) when prompting the user whether or not to continue.

When it is determined at step 630 to continue the configuration of the polymer processing apparatus, the routine proceeds to step 650. Alternatively, when it is determined not to continue configuring the polymer processing apparatus, the routine proceeds to step 640. At step 640 the configuration and control routine prompts the user for a new amount of blowing agent, the routine then proceeding back to step 610.

At step 650, the configuration and control routine configures the pressure and/or metering device to provide the appropriate amount of blowing agent needed to produce the desired foamed product. The configuration of the pressure and/or metering device performed at step 650 generally includes configuring the pressure and/or metering device to provide a particular mass flow rate of blowing agent. The configuration of the pressure and/or metering device may also include setting the pressure and/or metering device to provide the particular mass flow rate of blowing agent at a particular pressure, based upon a pressure of the molten polymeric material within the polymer processing space. For example, where the record selected at step 620 includes a particular value for the pressure of the polymeric material within the polymer processing space, and the pressure and/or metering device also controls the pressure, as well as the amount of blowing agent delivered to the polymer processing space, the pressure and/or metering device can be configured to provide the blowing agent to the polymer processing space at a pressure that is above that of the molten polymeric material to reduce the surge of the blowing agent into the molten polymeric material. As noted above, Applicants have empirically determined that a blowing agent pressure approximately 50-100 psi above the pressure of the molten polymeric material is sufficient for this purpose.

According to one embodiment of the present invention, the pressure and/or metering device is configured in the following manner. Based upon the volume of polymeric material in a charge or shot (which is known from the volume of the polymer processing space) and the melt density of the particular type of polymeric material being used, a shot weight may be determined (i.e., Shot Weight=Dosage Volume*Material Melt Density). The amount or dosage of blowing agent to be admixed in the charge or shot of polymeric material, in terms of mass, can be determined based upon the shot weight and the blowing agent amount specified by the user in step 610 (i.e., Blowing Agent Dosage/Shot=Shot Weight*Blowing Agent Amount). Based upon the blowing agent dosage in each charge or shot, and a shutoff valve open time (i.e., the amount of time one or a plurality of shutoff valves (e.g., valves 154, 155, 157, 159, and 161 in FIG. 1) is open), a mass flow rate for the blowing agent may be determined (i.e., Blowing Agent Flow Rate=(Blowing Agent Dosage/Shot)/Shutoff Valve Open Time). The shutoff valve open time may be determined in a number of ways, for example, based upon the screw recovery time. Alternatively, the shutoff valve open time may be provided by the user in response to a prompt for such information (not shown in FIG. 6). Once the Blowing Agent Flow Rate is determined, the configuration and control routine sets the pressure and/or metering device to provide the determined blowing agent flow rate, and the routine proceeds to step 660.

At step 660, the configuration and control routine configures and controls the polymer processing apparatus based upon the inputs provided by the user, inputs received from the polymer processing apparatus (e.g., polymer melt pressure, screw position, etc.), and the process parameter values of the database record selected at step 620. For example, at step 660, the configuration and control routine sets and controls valve opening via valve control output 230A for one or a plurality of valves (e.g., valves 154, 155, 157, 159, and 161 in FIG. 1), including the amount of time each valve is open, conditions for valve opening (e.g., based upon polymer melt pressure, based upon polymer volume, based upon screw position, etc.) Depending upon the particular type of polymer processing apparatus, the shutoff valve opening may be controlled so that the shutoff valve(s) do not open until a default condition, such as until the polymer melt pressure (corresponding to controller input 220A) reaches a desired value, until a particular volume of polymeric material has been provided to the polymer processing space, or until a delay time (e.g., based upon screw position and/or screw recovery time) has expired. Shutoff valve opening may be set to any of the above default conditions, or alternatively, the user may be prompted to provide the desired valve opening condition. For example, in addition to prompting the user for a shutoff valve open time, the routine can also prompt the user to specify conditions relating to the opening of the shutoff valve(s), rather than determining these based upon a particular default setting. As both the shutoff valve open time and the conditions upon which the shutoff valve is opened need not be based upon input provided by the user, such steps are not depicted in FIG. 6. In step 660, the controller can also monitor and control the melt pressure of the polymeric material based upon input 220A and output 240, to ensure that the polymer melt pressure is maintained at a steady value. The configuration and control routine continues controlling the polymer processing apparatus until processing is interrupted, (for example, until a desired number of molded articles are produced, until a maintenance interval is reached, etc.), whereupon the routine then terminates.

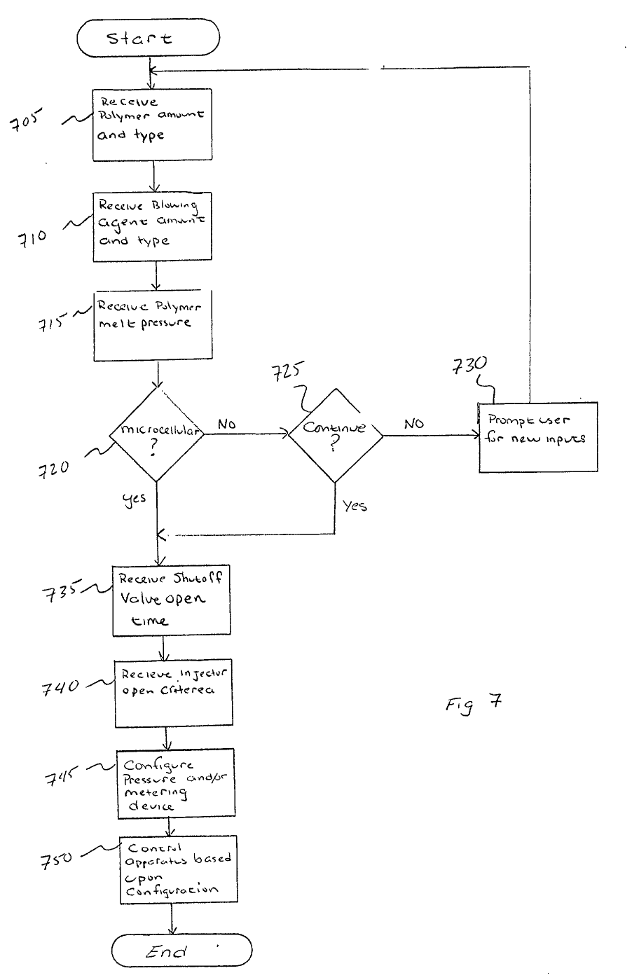

FIG. 7 is an exemplary flow diagram of a configuration and control routine according to another embodiment of the present invention that may be performed by the polymer processing apparatus controller 200 of FIG. 5 to produce a foamed product. In this illustrative example, the configuration and control routine is again adapted to produce a microcellular product, but may also be used to produce a non-microcellular foamed product. In contrast to the configuration and control routine of FIG. 6, the configuration and control routine of FIG. 7 may be used with a variety of different types of polymer processing apparatus, including the injection/intrusion molding system described with respect to FIG. 1. In general, because the configuration and control routine of FIG. 7 may be used with a variety of different types of polymer processing equipment, and with a variety of different types of polymers and blowing agents, the configuration and control routine of FIG. 7 requests additional information from the user relating to the particulars of their process. It should be appreciated that when these particulars are known in advance, many of the steps described with respect to FIG. 7 may be omitted, and the routine will resemble that described above with respect to FIG. 6.

At step 705 the configuration and control routine receives an input from the user specifying the amount and type of polymer to be used in forming the foamed product. As discussed above with respect to FIGS. 4 and 6 with respect to the amount of blowing agent, the routine may prompt the user to specify the amount of polymer in a particular manner. For example, the amount of polymer may be specified in terms of a mass amount of polymer to be provided in a charge or shot, or alternatively, the amount of the polymer may be specified indirectly, by specifying the volume amount of polymer to be provided in a charge or shot. The type of polymer may be specified by its trade name (e.g., Nova 2282 PS), by its chemical formula, or based upon a menu indicating various types of polymeric material with which the apparatus may be used. After receiving the type and amount of polymer to be provided to the polymer processing space, the routine proceeds to step 710.

At step 710, the configuration and control routine receives an input from the user specifying the amount and type of blowing agent to be used in forming the foamed product. The routine may prompt the user to specify the type of blowing agent in a particular manner, for example, by prompting the user to provide the type of blowing agent based upon its chemical name or formula, or may provide a menu listing a number of choices. Where the polymer processing apparatus is preconfigured, such that it is connected to a particular source of blowing agent, the type of blowing agent need not be specified, as it will be known to the controller. The amount of blowing agent may also be specified in a number of different ways, such as by being specified directly as a weight or mass percentage of the amount of polymeric material in a charge or shot, or as a weight or mass amount of blowing agent in a charge or shot, or indirectly, such as by specifying a desired cell size. In the exemplary configuration and control routine of FIG. 7, it is assumed that the amount of blowing agent is specified as a mass or weight percentage of the amount of polymeric material in a charge or shot, although as described further below, the present invention is not so limited. After receiving the amount (and optionally type) of blowing agent at step 710, the configuration and control routine proceeds to step 715.

At step 715, the configuration and control routine receives an input from the user specifying the desired melt pressure of the polymeric material within the polymer processing space. It should be appreciated that step 715 may not be required, as an appropriate melt pressure may be obtained by the configuration and control routine by accessing the database (e.g., database 300 in FIG. 3). However, because the particular melt pressure desired by the user may not necessarily be present in the database, or because the user may desire a different melt pressure, the user is provided with an ability to set this parameter.

At step 720 the configuration and control routine determines whether a microcellular foamed product can be produced given the various user input parameters received in steps 705 through 715. This determination may again be made by querying the preconfigured database in a manner similar to that described with respect to FIG. 4, and selecting all records that include the specified user parameters. Where the database query returns a single record or a number of records that correspond to a microcellular foamed product, the controller determines that a microcellular product can be produced and the routine proceeds to step 735. As described above with respect to FIG. 6, where the database query returns a single record, the routine may prompt the user to confirm their selection prior to proceeding to step 735. Alternatively, where the database query returns more than one record, the routine may simply select a single record according to any suitable method, or may request a selection of a particular record from the user, the routine then proceeding to step 735. Alternatively, where the database query returns no records, the controller determines that a microcellular product cannot be produced and the routine proceeds to step 725.

At step 725 a determination is made whether to continue configuring the polymer processing apparatus despite the fact that a microcellular product may not be produced. The determination that is made at step 725 is based upon input received from the user, for example, in response to a prompt from the controller. It should be appreciated that because the polymer processing apparatus may be used to produce microcellular foamed products as well as other types of foamed products, the user may desire to continue configuring the polymer processing apparatus to produce the specified foamed product, despite the fact that the foamed product produce thereby may not be microcellular. Alternatively, because the records stored in the database may not be complete (e.g., the records may be based upon empirical data obtained using similar, but not identical, polymer processing equipment, the data may be outdated, the user may have some specialized knowledge not reflected in the database, etc.), the user is provided the opportunity to continue the configuration. It should be appreciated that to aid the user in determining whether to continue, the routine may display the product characteristics of the foamed product that is expected to be produced (e.g., cell size, density, etc.) when prompting the user whether or not to continue.

When it is determined at step 725 to continue the configuration of the polymer processing apparatus, the routine proceeds to step 735. Alternatively, when it is determined not to continue configuring the polymer processing apparatus, the routine proceeds to step 730, wherein the configuration and control routine prompts the user for new inputs, the routine then proceeding back to step 705.

At step 735 and 740, the configuration and control routine receives a number of additional parameters from the user relating to the desired operation of the polymer processing apparatus. For example, at step 735 the configuration and control routine receives an input from the user specifying the shutoff valve open time that is desired. Although a default value for the shutoff valve open time may be used as described in FIG. 6, the user may wish to specify a different amount of time. Similarly, in step 740, the user can specify various criteria upon which the shutoff valve (or valves) is (are) opened, rather than having the shutoff valve opening criteria set to a default condition. In each of steps 735 and 740, the routine can prompt the user for a particular value, can display to the user the various values or choices that are permitted, and may optionally display to the user any default values that can be selected. After receiving a number of additional inputs from the user in steps 735 and 740, the configuration and control routine proceeds to step 745.

At step 745, the configuration and control routine configures the pressure and/or metering device to provide the appropriate amount of blowing agent needed to produce the desired foamed product. The configuration of the pressure and/or metering device performed at step 745 is similar to that described above in the configuration and control routine of FIG. 6. For example, based upon the type and amount of polymeric material specified in step 705, the type and amount of blowing agent provided in step 710, and the shutoff valve open time provided in step 735, the pressure and/or metering device can be configured to provide a particular mass flow rate of blowing agent to the polymer processing space based upon the equations described above with respect to FIG. 6. In addition, based upon the polymer melt pressure provided by the user, the pressure and/or metering device can also be configured to provide the blowing agent to the polymer processing space at a particular pressure, for example, a pressure that is above that of the polymer melt pressure. Upon determining the appropriate mass flow rate of blowing agent to be provided to the polymer processing space, and optionally, the pressure at which the blowing agent is to be provided, the pressure and/or metering device is then set to provide the blowing agent according to a control signal provided on output 230B (FIG. 5).

After configuring the pressure and/or metering device in step 745, the configuration and control routine proceeds to step 750, wherein the routine configures and controls the polymer processing apparatus based upon the inputs provided by the user, and inputs received from the polymer processing apparatus (e.g., polymer melt pressure, screw position, etc.) For example, at step 750, the configuration and control routine sets and controls valve opening via valve control output 230A for one or a plurality of valves (e.g., valves 154, 155, 157, 159, and 161 in FIG. 1), including the amount of time each valve is open, conditions for valve opening (e.g., based upon polymer melt pressure, based upon polymer volume, based upon screw position, etc.) The controller can also monitor and control the melt pressure of the polymeric material based upon the actual value of the polymer melt pressure (received on input 220A) to ensure that the polymer melt pressure is maintained at a steady value. Actual values of process parameters such as the actual mass flow rate of blowing agent, the actual value of the pressure of the blowing agent, and the actual value of the polymer melt pressure, as well as other parameters can be provided or displayed to the user, based upon input signal received on inputs 220A, 220B, and 220C. The configuration and control routine continues controlling the polymer processing apparatus until processing is interrupted, (for example, until a desired number of molded articles are produced, until a maintenance interval is reached, etc.), whereupon the routine then terminates.

It should be appreciated the above described configuration and control routines are exemplary only, and that a number of alterations and variations to these routine may be provided. For example, because various parameter values such as polymer melt pressure, blowing agent mass flow rate, and blowing agent pressure can be monitored by the controller, the user can be alerted whenever an actual parameter departs appreciably from the value configured by the routine.

Moreover, although certain process parameters used by the routine have been described as being provided in a particular manner, the present invention is not so limited. For example, rather than specifying the amount of polymeric material being provided to the polymer processing space as a volume, the amount of polymeric material may be specified in a number of other ways, such as by specifying the mass amount of polymeric material (including runners) in a charge or shot, or by specifying an amount of polymeric material in a solid product for which a similarly dimensioned foamed product is desired (e.g., where polymer processing apparatus previously used to produce the solid product has been modified to produce a similarly dimensioned foamed product). It should be appreciated that where the amount of polymeric material is specified in terms of the amount of polymeric material used to form a solid product, the amount of polymeric material needed to form the similarly dimensioned product will be less than that used to form the solid product. However, a new amount of polymeric material may be determined based upon the amount of blowing agent to be admixed therewith and the amount of polymeric material previously used to form the solid product.

Similarly, the amount of blowing agent that is to be admixed with the amount of polymeric material may be specified directly, such as by specifying a mass amount of blowing agent to be provided to the polymer processing space relative to the mass amount of polymeric material, or indirectly, such as by specifying a desired weight reduction in the foamed product relative to the solid product, by specifying a desired density of the foamed product, a desired average cell size or void volume of the foamed product, etc.

It should be appreciated that where a microcellular foamed product is to be produced, the amount of information that need be provided by a user may be limited to only a single input indicative of the amount of polymeric material being provided to the polymer processing space. From such an input, the amount of the blowing agent to be admixed therewith may be automatically determined. Moreover, where the particulars of the polymer processing apparatus are known in advance, the blowing agent delivery system may be automatically configured to provide the appropriate amount of the blowing agent, and at the appropriate time (e.g., based upon one or more valve opening conditions). Other process parameters may of course be provided, depending upon the degree of control required.

Although various aspects of the present invention have primarily been described above with respect to injection/intrusion molding, it should be appreciated that the present invention is not so limited. For example, in the configuration and control routines of FIGS. 6 and 7, steps 650 and 660 (FIG. 6) and steps 745 and 750 may be adapted for use with other types of polymer processing apparatus. For example, when used with a molding machine in which a predetermined mass flow rate of blowing agent is provided to one or more shutoff valves (e.g., shutoff valve 155, 157, 154, 159, and 161 in FIG. 1), the configuring of the pressure and/or metering device performed at steps 650 and 745 may include determining an amount of time each of the one or more valves is open, based upon the predetermined mass flow rate of the blowing agent and the amount of blowing agent to be provided to the polymer processing space. In such a continuous process, each of the one or more shutoff valves may be provided with a periodic control signal in which the valve is open during a first period and closed during a second. Alternatively still, in such a continuous process, each of the one or more shutoff valves may be kept open, and a control signal provided to control the degree to which each valve is open, based upon the amount of the blowing agent to be provided to the polymer processing space over time.

Those skilled in the art would readily appreciate that all parameters listed herein are meant to be exemplary and that actual parameters will depend upon the specific application for which the methods and apparatus of the present invention are used. It is, therefore, to be understood that the foregoing embodiments are presented by way of example only and that, within the scope of the appended claims and equivalents thereto, the invention may be practiced otherwise than as specifically described.

What is claimed is:

1. A computer readable medium encoded with a program that, when executed on a polymer processing apparatus controller, performs a method comprising acts of:
(A) receiving a first input indicative of an amount of a polymeric material to be provided to a polymer processing space of a polymer processing apparatus; and
(B) automatically determining an amount of a blowing agent to be provided to the polymer processing space to form a foamed product based upon the amount of polymeric material.

2. The computer readable medium of claim 1, wherein the act (B) includes an act of automatically determining a plurality of amounts of the blowing agent, each of the plurality of amounts of the blowing agent including a sufficient amount of the blowing agent to form a microcellular foamed product.

3. The computer readable medium of claim 2, further comprising acts of:
(C) displaying the plurality of amounts of the blowing agent on a display device; and
(D) configuring, responsive to a second input selecting one of the plurality of amounts of the blowing agent, a blowing agent delivery system to provide the selected one of the plurality of amounts of the blowing agent to the polymer processing space.

4. The computer readable medium of claim 1, wherein the first input is indicative of the amount of polymeric material to be provided to the polymer processing space when forming a solid product, the method further comprising an act of:
(C) receiving a second input indicative of a desired weight reduction in the solid product;
wherein the act (B) includes an act of automatically determining the amount of the blowing agent to be provided to the polymer processing space to form a microcellular foamed product having the desired weight reduction relative to the solid product.

5. The computer readable medium of claim 4, further comprising an act of:
(D) determining a new amount of the polymeric material to be provided to the polymer processing space to form the microcellular foamed product having the desired weight reduction relative to the solid product.

6. The computer readable medium of claim 5, further comprising an act of:
(E) configuring a blowing agent delivery system to provide the amount of the blowing agent to the polymer processing space to form the microcellular foamed product having the desired weight reduction relative to the solid product.

7. The computer readable medium of claim 6, further comprising an act of:
(F) configuring the polymer processing apparatus to supply the new amount of the polymeric material to the polymer processing space.

8. The computer readable medium of claim 4, further comprising an act of:
(D) configuring a blowing agent delivery system to provide the amount of the blowing agent to the polymer processing space to form the microcellular foamed product having the desired weight reduction relative to the solid product.

9. The computer readable medium of claim 1, wherein the first input is indicative of the amount of polymeric material to be provided to the polymer processing space when forming a solid product, and wherein the act (B) includes an act of automatically determining a plurality of amounts of the blowing agent to be provided to the polymer processing space, each of the plurality of amounts of the blowing agent including a sufficient amount of the blowing agent to form a microcellular foamed product, the method further comprising an act of:
(C) displaying, on a display device, the plurality of amounts of the blowing agent along with an indication of a weight reduction in the microcellular foamed product relative to the solid product for each of the plurality of amounts of the blowing agent.

10. The computer readable medium of claim 9, wherein the method further comprises an act of:
(D) configuring, responsive to a second input selecting one of the plurality of amounts of the blowing agent, a blowing agent delivery system to provide the selected one of the plurality of amounts of the blowing agent to the polymer processing space.

11. The computer readable medium of claim 10, further comprising an act of:
(E) determining a new amount of the polymeric material to be provided to the polymer processing space to form the microcellular foamed product based upon the selected one of the plurality of amounts of the blowing agent.

12. The computer readable medium of claim 11, further comprising an act of:
(F) configuring the polymer processing apparatus to supply the new amount of the polymeric material to the polymer processing space.

13. The computer readable medium of claim 1, wherein the first input is indicative of a mass amount of the polymeric material to be provided to the polymer processing space, and wherein the act (B) includes an act of automatically determining the amount of the blowing agent to be provided to the polymer processing space to form a microcellular foamed product based upon the mass amount of the polymeric material.

14. The computer readable medium of claim 13, wherein the method further comprises an act of:
(C) receiving a second input indicative of a type of the blowing agent;
wherein the act (B) includes an act of automatically determining the amount of the blowing agent to be provided to the polymer processing space to form the microcellular foamed product based upon the mass amount of the polymeric material and the type of the blowing agent.

15. The computer readable medium of claim 13, wherein the method further comprises acts of:
(D) receiving a second input indicative of a type of the blowing agent; and
(E) receiving a third input indicative of a type of the polymeric material;
wherein the act (B) includes an act of automatically determining the amount of the blowing agent to be provided to the polymer processing space based upon the mass amount of the polymeric material, the type of the polymeric material, and the type of the blowing agent.

16. The computer readable medium of claim 1, wherein the first input is indicative of a mass amount of the polymeric material in a microcellular foamed product, and wherein the act (B) includes an act of automatically determining the amount of the blowing agent to be provided to the polymer processing space to form the microcellular foamed product based upon the mass amount of the polymeric material in the microcellular foamed product.

17. The computer readable medium of claim 16, wherein the method further comprises an act of:
(C) receiving a second input indicative of a type of the blowing agent;
wherein the act (B) includes an act of automatically determining the amount of the blowing agent to be provided to the polymer processing space based upon the mass amount of the polymeric material in the microcellular foamed product and the type of the blowing agent.

18. The computer readable medium of claim 16, wherein the method further comprises acts of:
(D) receiving a second input indicative of a type of the blowing agent; and
(E) receiving a third input indicative of a type of the polymeric material;
wherein the act (B) includes an act of automatically determining the amount of the blowing agent to be provided to the polymer processing space based upon the mass amount of the polymeric material in the microcellular foamed product, the type of the polymeric material, and the type of the blowing agent.

19. The computer readable medium of claim 1, wherein the first input is indicative of a volume amount of the polymeric material to be provided to the polymer processing space, the method further comprising an act of:
(C) receiving a second input indicative of a type of the polymeric material;
wherein the act (B) includes an act of automatically determining the amount of the blowing agent to be provided to the polymer processing space to form a microcellular foamed product based upon a mass amount of the polymeric material to be provided to the polymer processing space; and
wherein the mass amount of the polymeric material is determined based upon the type of the polymeric material, a material melt density of the type of the polymeric material, and the volume amount of the polymeric material.

20. The computer readable medium of claim 19, wherein the method further comprises an act of:
(D) receiving a third input indicative of a type of the blowing agent;
wherein the act (B) includes an act of automatically determining the amount of the blowing agent to be provided to the polymer processing space to form the microcellular foamed product based upon the mass amount of the polymeric material to be provided to the polymer processing space and the type of the blowing agent.

21. The computer readable medium of claim 1, wherein:
the first input is indicative of a volume amount of the polymeric material to be provided to the polymer processing space;
wherein the act (B) includes an act of automatically determining the amount of the blowing agent to be provided to the polymer processing space to form a microcellular foamed product based upon a mass amount of the polymeric material to be provided to the polymer processing space; and
wherein the mass amount of the polymeric material is determined based upon a material melt density of the polymeric material, and the volume amount of the polymeric material.

22. The computer readable medium of claim 21, wherein the method further comprises an act of:
(C) receiving a second input indicative of a mass percentage of the blowing agent to be provided to the polymer processing space relative to the mass amount of the polymeric material to be provided to the polymer processing space; and
wherein the act (B) includes an act of automatically determining the amount of the blowing agent to be provided to the polymer processing space to form the microcellular foamed product based upon the mass amount of the polymeric material and the mass percentage of the blowing agent.

23. The computer readable medium of claim 22, wherein the method further comprises an act of:
(D) configuring a blowing agent delivery system to provide the amount of the blowing agent to the polymer processing space.

24. The computer readable medium of claim 23, wherein the blowing agent delivery system includes at least one valve through which the blowing agent is provided to the polymer processing space;
wherein the blowing agent delivery system provides a predetermined flow rate of the blowing agent to the at least one valve; and
wherein the act (D) includes an act of determining an open time of the at least one valve based upon the amount of the blowing agent to be provided to the polymer processing space and the predetermined flow rate.

25. The computer readable medium of claim 24, wherein the act (D) further includes an act of controlling the at least one valve according to the open time.

26. The computer readable medium of claim 23, wherein the blowing agent delivery system includes at least one valve through which the blowing agent is provided to the polymer processing space;
wherein the blowing agent delivery system provides a predetermined flow rate of the blowing agent to the at least one valve; and
wherein the act (D) includes an act of determining a position to which the at least one valve is opened based upon the amount of the blowing agent to be provided to the polymer processing space and the predetermined flow rate.

27. The computer readable medium of claim 23, wherein:
the polymer processing apparatus is an injection molding machine that includes a screw having a screw recovery time;
the blowing agent delivery system includes at least one valve; and
the act (D) includes an act of setting a flow rate of the blowing agent delivery system based upon the amount of blowing agent to be provided to the polymer processing space and the screw recovery time.

28. The computer readable medium of claim 23, wherein the blowing agent delivery system includes at least one valve having a valve open time during which the blowing agent flows through the at least one valve and into the polymer processing space, the method further comprising an act of:
(E) receiving a third input indicative of the valve open time;
wherein the act (D) includes an act of setting a flow rate of the blowing agent delivery system based upon the amount of blowing agent to be provided to the polymer processing space and the valve open time.

29. The computer readable medium of claim 28, wherein the method further comprises acts of:
(F) receiving a fourth input indicative of a valve opening condition of the at least one valve; and
(G) controlling an opening of the at least one valve based upon the valve opening condition.

30. The computer readable medium of claim 28, wherein the polymer processing apparatus is one of an injection molding machine, a blow molding machine, and an extruder.

31. The computer readable medium of claim 28, further comprising an act of:
(F) monitoring an actual flow rate of the blowing agent that is provided to the polymer processing space by the blowing agent delivery system.

32. The computer readable medium of claim 28, further comprising an act of:
(F) receiving a fourth input indicative of an actual melt pressure of the polymeric material within the polymer processing space;
wherein the act (D) includes an act of setting a pressure of the blowing agent to be provided to the polymer processing space by the blowing agent delivery system approximately 50-100 psi above the actual melt pressure of the polymeric material.

33. The computer readable medium of claim 28, further comprising an act of:
(F) receiving a fourth input indicative of a desired melt pressure of the polymeric material within the polymer processing space;
wherein the act (D) includes an act of setting a pressure of the blowing agent to be provided to the polymer processing space by the blowing agent delivery system approximately 50-100 psi above the desired melt pressure of the polymeric material.

34. The computer readable medium of claim 33, further comprising an act of:
(G) monitoring an actual pressure of the polymeric material within the polymer processing space.

35. The computer readable medium of claim 34, further comprising an act of:
(H) monitoring an actual pressure of the blowing agent that is provided to the polymer processing space by the blowing agent delivery system.

36. The computer readable medium of claim 35, further comprising an act of:
(I) providing an indication to a user of the polymer processing apparatus when one of the actual pressure of the polymeric material within the polymer processing space is not approximately equal to the desired melt pressure; and
the actual pressure of the blowing agent is more than approximately 100 psi above the desired melt pressure of the polymeric material.

37. The computer readable medium of claim 28, further comprising an act of:
(F) receiving a fourth input indicative of a desired melt pressure of the polymeric material within the polymer processing space;
wherein the act (D) includes an act of setting a pressure of the blowing agent to be provided to the polymer processing space by the blowing agent delivery system to a pressure that maintains a single-phase solution of the polymeric material and the blowing agent within the polymer processing space.

38. The computer readable medium of claim 28, further comprising an act of:
(F) receiving a fourth input indicative of an actual melt pressure of the polymeric material within the polymer processing space;
wherein the act (D) includes an act of setting a pressure of the blowing agent to be provided to the polymer processing space by the blowing agent delivery system to a pressure that maintains a single-phase solution of the polymeric material and the blowing agent within the polymer processing space.

39. The computer readable medium of claim 1, wherein the first input is indicative of a volume amount of the polymeric material to be provided to the polymer processing space, the method further comprising an act of:
(C) receiving a second input indicative of a mass percentage of the blowing agent to be provided to the polymer processing space relative to a mass amount of the polymeric material to be provided to the polymer processing space; and
wherein the act (B) includes an act of automatically determining the amount of the blowing agent to be provided to the polymer processing space to form the foamed product based upon the volume amount of the polymeric material to be provided to the polymer processing space, a material melt density of the polymeric material, and the mass percentage of the blowing agent.

40. The computer readable medium of claim 39, wherein the method further comprises an act of:
(D) configuring a blowing agent delivery system to provide the amount of the blowing agent to the polymer processing space.

41. The computer readable medium of claim 40, wherein the blowing agent delivery system includes at least one valve through which the blowing agent is provided to the polymer processing space;
wherein the blowing agent delivery system provides a predetermined flow rate of the blowing agent to the at least one valve; and
wherein the act (D) includes an act of determining an open time of the at least one valve based upon the amount of the blowing agent to be provided to the polymer processing space and the predetermined flow rate.

42. The computer readable medium of claim 41, wherein the act (D) further includes an act of controlling the at least one valve according to the open time.

43. The computer readable medium of claim 40, wherein the blowing agent delivery system includes at least one valve through which the blowing agent is provided to the polymer processing space;
wherein the blowing agent delivery system provides a predetermined flow rate of the blowing agent to the at least one valve; and
wherein the act (D) includes an act of determining a position to which the at least one valve is opened based upon the amount of the blowing agent to be provided to the polymer processing space and the predetermined flow rate.

44. The computer readable medium of claim 40, wherein:
the polymer processing apparatus is an injection molding machine that includes a screw having a screw recovery time;
the blowing agent delivery system includes at least one valve; and
the act (D) includes an act of setting a flow rate of the blowing agent delivery system based upon the amount of blowing agent to be provided to the polymer processing space and the screw recovery time.

45. The computer readable medium of claim 40, wherein the blowing agent delivery system includes at least one valve having a valve open time during which the blowing agent flows through the at least one valve and into the polymer processing space, the method further comprising an act of:
(E) receiving a third input indicative of the valve open time;
wherein the act (D) includes an act of setting a flow rate of the blowing agent delivery system based upon the amount of blowing agent to be provided to the polymer processing space and the valve open time.

46. The computer readable medium of claim 45, wherein the method further comprises acts of:
(F) receiving a fourth input indicative of a valve opening condition of the at least one valve; and
(G) controlling an opening of the at least one valve based upon the valve opening condition.

47. The computer readable medium of claim 45, wherein the polymer processing apparatus is one of an injection molding machine, a blow molding machine, and an extruder.

48. The computer readable medium of claim 39, further comprising an act of:
(F) determining whether the amount of the blowing agent automatically determined in act (B) is within a predetermined range of amounts of the blowing agent to form a microcellular foamed product.

49. The computer readable medium of claim 48, further comprising an act of:
(G) providing an indication to a user of the polymer processing apparatus when it is determined in the act (F) that the amount of the blowing agent is not within the predetermined range of amounts of the blowing agent to form the microcellular foamed product.

50. The computer readable medium of claim 49, further comprising an act of:
(H) requesting, responsive to the act (G) a new mass percentage of the blowing agent to be provided to the polymer processing space relative to the mass amount of the polymeric material to be provided to the polymer processing space when it is determined in the act (F) that the amount of the blowing agent is not within the predetermined range of amounts of the blowing agent to form the microcellular foamed product.

51. The computer readable medium of claim 49, further comprising an act of:
(H) configuring a blowing agent delivery system to provide the amount of the blowing agent automatically determined in act (B) when it is determined in the act (F) that the amount of the blowing agent is not within the predetermined range of amounts of the blowing agent to form the microcellular foamed product.

52. The computer readable medium of claim 45, further comprising an act of:
(F) monitoring an actual flow rate of the blowing agent that is provided to the polymer processing space by the blowing agent delivery system.

53. The computer readable medium of claim 52, further comprising acts of:
(G) receiving a fourth input indicative of a desired melt pressure of the polymeric material within the polymer processing space; and
(H) monitoring an actual pressure of the polymeric material within the polymer processing space.

54. The computer readable medium of claim 53, further comprising an act of:
(I) providing an indication to a user of the polymer processing apparatus when the actual pressure of the polymeric material within the polymer processing space is not approximately equal to the desired melt pressure.

55. The computer readable medium of claim 1, wherein the polymer processing apparatus is one of an injection molding machine, a blow molding machine, and an extruder.

56. A method comprising acts of:
(A) receiving a first input indicative of an amount of a polymeric material to be provided to a polymer processing space of a polymer processing apparatus; and
(B) automatically configuring, based upon the amount of polymeric material to be provided to the polymer processing space, a blowing agent delivery system to provide an amount of blowing agent to the polymer processing space to form a foamed product.

57. The method of claim 56, wherein the first input is indicative of the amount of polymeric material to be provided to the polymer processing space when forming a solid product, the method further comprising an act of:
(C) determining, based upon the amount of polymeric material to be provided to the polymer processing space, a plurality of amounts of the blowing agent to be provided to the polymer processing space, each of the plurality of amounts of the blowing agent including a sufficient amount of the blowing agent to form a microcellular foamed product;
(D) displaying, on a display device, the plurality of amounts of the blowing agent along with an indication of a weight reduction in the microcellular foamed product relative to the solid product for each of the plurality of amounts of the blowing agent; and
(E) receiving a second a second input selecting one of the plurality of amounts of the blowing agent;
wherein the act (B) includes an act of automatically configuring, responsive to the act (E), the blowing agent delivery system to provide the selected one of the plurality of amounts of the blowing agent to the polymer processing space.

58. The method of claim 56, wherein the first input is indicative of a volume amount of the polymeric material to be provided to the polymer processing space to form a microcellular foamed product, the method further comprising an act of:
(C) determining an amount of the blowing agent to be provided to the polymer processing space to form the microcellular foamed product based upon a material melt density of the polymeric material and the volume amount of the polymeric material;
wherein the act (B) includes an act of automatically configuring the blowing agent delivery system to provide the amount of the blowing agent determined in act (C).

59. The method of claim 58, wherein:
the polymer processing apparatus is an injection molding machine that includes a screw having a screw recovery time;
the blowing agent delivery system includes at least one valve; and
the act (B) includes an act of automatically setting a flow rate of the blowing agent delivery system based upon the amount of blowing agent to be provided to the polymer processing space and the screw recovery time.

60. The method of claim 58, wherein the blowing agent delivery system includes at least one valve having a valve open time during which the blowing agent flows through the at least one valve and into the polymer processing space, the method further comprising an act of:
(D) receiving a second input indicative of the valve open time;
wherein the act (B) includes an act of automatically setting a flow rate of the blowing agent delivery system based upon the amount of blowing agent to be provided to the polymer processing space and the valve open time.

61. The method of claim 60, further comprising acts of:
(E) receiving a fourth input indicative of a valve opening condition of the at least one valve; and
(F) automatically controlling an opening of the at least one valve based upon the valve opening condition.

62. The method of claim 60, further comprising an act of:
(E) monitoring an actual flow rate of the blowing agent that is provided to the polymer processing space by the blowing agent delivery system.

63. The method of claim 60, further comprising an act of:
(E) receiving a fourth input indicative of an actual melt pressure of the polymeric material within the polymer processing space;
wherein the act (B) includes an act of automatically setting a pressure of the blowing agent to be provided to the polymer processing space by the blowing agent delivery system approximately 50-100 psi above the actual melt pressure of the polymeric material.

64. The method of claim 60, further comprising an act of:
(E) receiving a fourth input indicative of a desired melt pressure of the polymeric material within the polymer processing space;
wherein the act (B) includes an act of automatically setting a pressure of the blowing agent to be provided to the polymer processing space by the blowing agent delivery system approximately 50-100 psi above the desired melt pressure of the polymeric material.

65. The method of claim 64, further comprising an act of:
(F) monitoring an actual pressure of the polymeric material within the polymer processing space.

66. The method of claim 65, further comprising an act of:
(G) monitoring an actual pressure of the blowing agent that is provided to the polymer processing space by the blowing agent delivery system.

67. The method of claim 66, further comprising an act of:
(H) providing an indication to a user of the polymer processing apparatus when one of the actual pressure of the polymeric material within the polymer processing space is not approximately equal to the desired melt pressure; and
the actual pressure of the blowing agent is more than approximately 100 psi above the desired melt pressure of the polymeric material.

68. The method of claim 60, further comprising an act of:
(E) receiving a fourth input indicative of a desired melt pressure of the polymeric material within the polymer processing space;
wherein the act (B) includes an act of automatically setting a pressure of the blowing agent to be provided to the polymer processing space by the blowing agent delivery system to a pressure that maintains a single-phase solution of the polymeric material and the blowing agent within the polymer processing space.

69. The method of claim 60, further comprising an act of:
(E) receiving a fourth input indicative of an actual melt pressure of the polymeric material within the polymer processing space;
wherein the act (B) includes an act of automatically setting a pressure of the blowing agent to be provided to the polymer processing space by the blowing agent delivery system to a pressure that maintains a single-phase solution of the polymeric material and the blowing agent within the polymer processing space.

70. The method of claim 56, wherein the first input is indicative of a volume amount of the polymeric material to be provided to the polymer processing space, the method further comprises acts of:
(C) receiving a second input indicative of a mass percentage of the blowing agent to be provided to the polymer processing space relative to a mass amount of the polymeric material to be provided to the polymer processing space;
(D) determining the mass amount of the polymeric material to be provided to the polymer processing space based upon the volume amount of the polymeric material and a material melt density of the polymeric material; and
(E) determining an amount of the blowing agent to be provided to the polymer processing space to form the foamed product based upon the mass amount of the polymeric material and the mass percentage of the blowing agent;
wherein the act (B) includes an act of automatically configuring the blowing agent delivery system to provide the amount of the blowing agent determined in act (E).

71. The method of claim 70, wherein:
the polymer processing apparatus is an injection molding machine that includes a screw having a screw recovery time;
the blowing agent delivery system includes at least one valve; and
the act (B) includes an act of automatically setting a flow rate of the blowing agent delivery system based upon the amount of blowing agent to be provided to the polymer processing space and the screw recovery time.

72. The method of claim 70, wherein the blowing agent delivery system includes at least one valve having a valve open time during which the blowing agent flows through the at least one valve and into the polymer processing space, the method further comprising an act of:
(D) receiving a second input indicative of the valve open time;
wherein the act (B) includes an act of automatically setting a flow rate of the blowing agent delivery system based upon the amount of blowing agent to be provided to the polymer processing space and the valve open time.

73. The method of claim 72, further comprising acts of:
(G) receiving a fourth input indicative of a valve opening condition of the at least one valve; and
(H) automatically controlling an opening of the at least one valve based upon the valve opening condition.

74. The method of claim 72, further comprising an act of:
(G) monitoring an actual flow rate of the blowing agent that is provided to the polymer processing space by the blowing agent delivery system.

75. The method of claim 72, further comprising acts of:
(G) receiving a fourth input indicative of a desired melt pressure of the polymeric material within the polymer processing space;
(H) monitoring an actual pressure of the polymeric material within the polymer processing space.

76. A method comprising acts of:
A) providing an amount of polymeric material to a polymer processing space;
(B) introducing an amount of a blowing agent to the polymer processing space; and
(C) controlling the introduction of the amount of the blowing agent in act (B) to provide a single-phase solution of the polymeric material and the blowing agent within the polymer processing space.

77. The method of claim 76, wherein the act (B) includes an act of injecting the amount of the blowing agent to the polymer processing space, the method further comprising an act of:
(D) monitoring a melt pressure of the polymeric material within the polymer processing space;
wherein the act (C) includes an act of regulating a pressure of the blowing agent that is injected into the polymer processing space to approximately 50-100 psi above the melt pressure of the polymeric material within the polymer processing space.

78. The method of claim 77, further comprising an act of:
(E) providing the single-phase solution of the polymeric material and the blowing agent to a mold.

79. A controller for a blowing agent delivery system, comprising:
a first input to receive at least one input signal, the at least one input signal including a first input signal indicative of an amount of a polymeric material to be provided to a polymer processing space of a polymer processing apparatus;
a processor, coupled to the first input, that determines, based at least upon the first input signal, an amount of a blowing agent to be provided by the blowing agent delivery system to the polymer processing space to form a foamed product; and
a first output, coupled to the processor and the blowing agent delivery system, to provide a first output signal to the blowing agent delivery system that automatically configures the blowing agent delivery system to provide the amount of the blowing agent to the polymer processing space.

80. The controller of claim 79, further comprising:
an input device, coupled to the first input and the processor, to receive the at least one input signal and provide the at least one input signal to the processor; and
a communication device, coupled to the first output and the processor, to receive the first output signal from the processor and provide the first output signal to the blowing agent delivery system.

81. The controller of claim 80, further comprising:
a display device, coupled to the processor;
wherein the at least one input signal includes a first input signal and a second input signal, the first input signal being indicative of the amount of polymeric material to be provided to the polymer processing space when forming a solid product;
wherein the processor, responsive to receipt of the first input signal from the input device,
automatically determines a plurality of amounts of the blowing agent to be provided to the polymer processing space, each of the plurality of amounts of the blowing agent including a sufficient amount of the blowing agent to form a microcellular foamed product, and
displays the plurality of amounts of the blowing agent on the display device along with an indication of a weight reduction in the microcellular foamed product relative to the solid product for each of the plurality of amounts of the blowing agent; and
wherein the processor, responsive to receipt of the second input signal selecting one of the plurality of amounts of the blowing agent, provides the first output signal to the communication device to automatically configure the blowing agent delivery system to provide the selected one of the plurality of amounts of the blowing agent to the polymer processing space.

82. The controller of claim 80, wherein the first input signal is indicative of a volume amount of the polymeric material to be provided to the polymer processing space to form a microcellular foamed product;
wherein the processor, responsive to receipt of the first input signal from the input device,
automatically determines the amount of the blowing agent to be provided by the blowing agent delivery system to the polymer processing space to form the microcellular foamed product based upon a material melt density of the polymeric material and the volume amount of the polymeric material, and
provides the first output signal to the communication device to automatically configure the blowing agent delivery system to provide the amount of the blowing agent to the polymer processing space to form the microcellular foamed product.

83. The controller of claim 82, wherein the polymer processing apparatus is an injection molding machine that includes a screw having a screw recovery time;
wherein the blowing agent delivery system includes at least one valve;
wherein the processor, responsive to receipt of the first input signal from the input device,
automatically determines a mass flow rate of the blowing agent to be provided by the blowing agent delivery system based upon the amount of blowing agent to be provided to the polymer processing space and the screw recovery time, and
provides the first output signal to the communication device to automatically configure the blowing agent delivery system to provide the mass flow rate of the blowing agent automatically determined by the processor.

84. The controller of claim 82, wherein the blowing agent delivery system includes at least one valve having a valve open time during which the blowing agent flows through the at least one valve and into the polymer processing space;
wherein the at least one input signal includes a second input signal indicative of the valve open time; and
wherein the processor, responsive to receipt of the second input signal from the input device,
automatically determines a mass flow rate of the blowing agent to be provided by the blowing agent delivery system based upon the amount of blowing agent to be provided to the polymer processing space and the valve open time, and
provides the first output signal to the communication device to automatically configure the blowing agent delivery system to provide the mass flow rate of the blowing agent automatically determined by the processor.

85. The controller of claim 84, further comprising:
a second output, coupled to the communication device and the blowing agent delivery system, to provide a second output signal;
wherein the at least one input signal includes a third input signal indicative of a valve opening condition of the at least one valve; and
wherein the processor, responsive to receipt of the third input signal, provides the second output signal to the communication device to automatically control the opening of the at least one valve based upon the valve opening condition.

86. The controller of claim 85, wherein the at least one input signal includes a fourth input signal indicative of a desired melt pressure of the polymeric material within the polymer processing space;
wherein the first output signal automatically configures the blowing agent delivery system to provide the amount of the blowing agent to the polymer processing space at a pressure approximately 50-100 psi above the desired melt pressure of the polymeric material.

87. The controller of claim 86, wherein the polymer processing apparatus is an injection molding machine having a screw and a screw back pressure regulator, the controller further comprising:
a third output, coupled to the communication device and the screw back pressure regulator, to provide a third output signal;
wherein the processor, responsive to the fourth input signal, provides the third output signal to the communication device to maintain the polymeric material at the desired melt pressure.

88. The controller of claim 87, further comprising:
a second input, coupled to the communication device, to receive a first pressure signal indicative of an actual melt pressure of the polymeric material within the polymer processing space and provide the first pressure signal to the processor;
a third input, coupled to the communication device, to receive a second pressure signal indicative of an actual pressure of the blowing agent delivered to the polymer processing space and provide the second pressure signal to the processor;
wherein the processor monitors the first and second pressure signals, and provides an indication to a user of the polymer processing apparatus when one of
the actual melt pressure of the polymeric material within the polymer processing space is not approximately equal to the desired melt pressure; and
the actual pressure of the blowing agent is more than approximately 100 psi above the desired melt pressure of the polymeric material.

89. The controller of claim 84, wherein the at least one input signal includes a third input signal indicative of a desired melt pressure of the polymeric material within the polymer processing space;
wherein the first output signal automatically configures the blowing agent delivery system to provide the amount of the blowing agent at a pressure that maintains a single-phase solution of the polymeric material and the blowing agent within the polymer processing space.

90. The controller of claim 84, further comprising:
a second input, coupled to the communication device, to receive a first pressure signal indicative of an actual melt pressure of the polymeric material within the polymer processing space;
wherein the first output signal automatically configures the blowing agent delivery system to provide the amount of the blowing agent to the polymer processing space at a pressure approximately 50-100 psi above the actual melt pressure of the polymeric material.

91. The controller of claim 80, wherein the first input signal is indicative of a volume amount of the polymeric material to be provided to the polymer processing space;
wherein the at least one input signal includes a second input signal indicative of a mass percentage of the blowing agent to be provided to the polymer processing space relative to a mass amount of the polymeric material to be provided to the polymer processing space; and
wherein the processor, responsive to receipt of the first and second input signals from the input device,
automatically determines the amount the blowing agent to be provided to the polymer processing space to form the foamed product based upon the volume amount of the polymeric material and the mass percentage of the blowing agent, and
provides the first output signal to the communication device to automatically configure the blowing agent delivery system to provide the amount of the blowing agent to the polymer processing space to form the foamed product.

92. The controller of claim 91, wherein the polymer processing apparatus is an injection molding machine that includes a screw having a screw recovery time;
wherein the blowing agent delivery system includes at least one valve;
wherein the processor, responsive to receipt of the first and second input signals from the input device,
automatically determines a mass flow rate of the blowing agent to be provided by the blowing agent delivery system based upon the amount of blowing agent to be provided to the polymer processing space and the screw recovery time, and
provides the first output signal to the communication device to automatically configure the blowing agent delivery system to provide the mass flow rate of the blowing agent automatically determined by the processor.

93. The controller of claim 91, wherein the blowing agent delivery system includes at least one valve having a valve open time during which the blowing agent flows through the at least one valve and into the polymer processing space;
wherein the at least one input signal includes a third input signal indicative of the valve open time; and
wherein the processor, responsive to receipt of the third input signal from the input device,
automatically determines a mass flow rate of the blowing agent to be provided by the blowing agent delivery system based upon the amount of blowing agent to be provided to the polymer processing space and the valve open time, and
provides the first output signal to the communication device to automatically configure the blowing agent delivery system to provide the mass flow rate of the blowing agent automatically determined by the processor.

94. The controller of claim 93, further comprising:
a second output, coupled to the communication device and the blowing agent delivery system, to provide a second output signal;
wherein the at least one input signal includes a fourth input signal indicative of a valve opening condition of the at least one valve; and
wherein the processor, responsive to receipt of the fourth input signal, provides the second output signal to the communication device to automatically control the opening of the at least one valve based upon the valve opening condition.

95. The controller of claim 94, wherein the at least one input signal includes a fifth input signal indicative of a desired melt pressure of the polymeric material within the polymer processing space;
wherein the first output signal automatically configures the blowing agent delivery system to provide the amount of the blowing agent to the polymer processing space at a pressure approximately 50-100 psi above the desired melt pressure of the polymeric material.

96. The controller of claim 95, wherein the polymer processing apparatus is an injection molding machine having a screw and a screw back pressure regulator, the controller further comprising:
a third output, coupled to the communication device and the screw back pressure regulator, to provide a third output signal;
wherein the processor, responsive to the fifth input signal, provides the third output signal to the communication device to maintain the polymeric material at the desired melt pressure.

97. The controller of claim 93, further comprising:
a second input, coupled to the communication device, to receive a first pressure signal indicative of an actual melt pressure of the polymeric material within the polymer processing space and provide the first pressure signal to the processor;
a third input, coupled to the communication device, to receive a second pressure signal indicative of an actual pressure of the blowing agent delivered to the polymer processing space and provide the second pressure signal to the processor;
wherein the processor monitors the first and second pressure signals, and provides an indication to a user of the polymer processing apparatus when one of
the actual melt pressure of the polymeric material within the polymer processing space is not approximately equal to the desired melt pressure; and
the actual pressure of the blowing agent is more than approximately 100 psi above the desired melt pressure of the polymeric material.

98. The controller of claim 93, wherein the at least one input signal includes a fourth input signal indicative of a desired melt pressure of the polymeric material within the polymer processing space;
wherein the first output signal automatically configures the blowing agent delivery system to provide the amount of the blowing agent at a pressure that maintains a single-phase solution of the polymeric material and the blowing agent within the polymer processing space.

99. The controller of claim 93, further comprising:
a second input, coupled to the communication device, to receive a first pressure signal indicative of an actual melt pressure of the polymeric material within the polymer processing space;
wherein the first output signal automatically configures the blowing agent delivery system to provide the amount of the blowing agent to the polymer processing space at a pressure approximately 50-100 psi above the actual melt pressure of the polymeric material.
